(19) United States
(12) Patent Application Publication
(10) Pub. No.: US 2005/0254226 A1
(43) Pub. Date: Nov. 17, 2005

(54) Ornament device, display device and electronic apparatus

(75) Inventors: Makoto Sawada, Tokyo (JP); Shunji Mimami, Tokyo (JP); Toshihiko Miyamura, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Casio Computer Co., Ltd., Tokyo (JP)

(21) Appl. No.: 11/050,925

(22) Filed: Feb. 4, 2005

(30) Foreign Application Priority Data
May 17, 2004 (JP) 2004-146594
May 31, 2004 (JP) 2004-161676

(51) Int. Cl. G01D 11/28; F21V 33/00

(52) U.S. Cl. 362/23; 362/184

(57) ABSTRACT

An ornament device includes a light transmittable dye sensitizing solar battery having a pair of light transmittable plates and a solar battery element between the light transmittable plates, and a light-projecting member provided in the side of the battery opposite to the sunlight incident side thereof and projecting light to the battery. A display device further includes, in addition to the solar battery and light-projecting member of the ornament device, a liquid crystal portion provided in an area between the light transmittable plates being different from an area in which the solar battery element is provided between them, and the light-projecting member projects light both of the solar battery liquid and the liquid crystal portion. An electronics apparatus includes a case for housing all of the structural elements of the ornament device and the display device.

### CROSS-REFERENCE TO RELATED APPLICATIONS

This application is based upon and claims the benefit of priority from the prior Japanese Patent Applications No. 2004-146594, filed May 17, 2004; and No. 2004-161676, filed May 31, 2004, the entire contents of both of which are incorporated herein by reference.

### BACKGROUND OF THE INVENTION

1. Field of the Invention

The present invention relates to an ornament device, a display device applied to various electronic apparatus such as a wristwatch and cellular phone, and an electronic apparatus provided with such an ornament device and a display device.

2. Description of the Related Art

In the prior art, an analog wristwatch provided with a solar battery is known. In such an analog wristwatch, a solar battery composed of amorphous silicon and an electroluminescence element for lighting a watch-face are placed on the same plane.

In such an analog wristwatch, however, as the solar battery and electroluminescence element are placed on the same plane, the light-receiving area of the solar battery is limited by the watch-face size. As a result, generation of electric power is not sufficient.

Further, as the light-emitting area of the electroluminescence element is also limited and the electroluminescence element is placed at the edge of the watch-face, it is difficult to obtain the light sufficient for the user to recognize the ornaments, such as, time marks on the watch-face and the hour, minute and second hands of a watch.

A digital wristwatch which indicates time by using a liquid crystal display panel is also known. In such a digital wristwatch, a solar battery and a liquid crystal display panel to display time are placed not overlapped one another on the watch case surface.

Even in such a wristwatch, however, the light-receiving area of a solar battery is limited by the case surface size and liquid crystal display panel. As a result, generation of electric power is not sufficient. To obtain sufficient electric power, the case surface area must be enlarged. This results in the increased size of a digital wristwatch itself.

Another type of conventional analog wrist watch is composed of a watch-face, a light guide plate provided under the watch-face and formed to have uneven lower surface, a solar battery placed under the light guide plate, and a light-emitting element placed sideway of the light guide plate. In this analog wristwatch, the light emitted from the light-emitting element is led into the inside of the light guide plate to be diffused and reflected by the uneven side of the light guide plate, and projected to the watch-face from the whole upper side of the light guide plate. Therefore, the user can visually recognize the watch-face and the hands of the analog wristwatch even in a dark place.

In such an analog wristwatch, however, the external light guided to the watch-face is scattered by the uneven side of the light guide plate, and the electric power generated by the solar battery is decreased.

### BRIEF SUMMARY OF THE INVENTION

According to one aspect of the present invention, an ornament device comprises: a light transmittable dye sensitizing solar battery, which has a pair of light transmittable plates and a dye sensitizing solar battery element provided between the pair of light transmittable plates; and a light-projecting member, which is provided in the side of the dye sensitizing solar battery opposite to the sunlight incident side thereof and projects light to the solar battery.

According to another aspect of the present invention, an electronic apparatus comprises: a light transmittable dye sensitizing solar battery, which has a pair of light transmittable plates and a dye sensitizing solar battery element provided between the pair of light transmittable plates; a light-projecting member, which is provided in the side of the dye sensitizing solar battery opposite to the sunlight incident side thereof and projects light to the dye sensitizing solar battery; an ornament portion, which is provided on at least one of the pair of light transmittable plates; and an apparatus case, which houses the light transmittable dye sensitizing solar battery, light-projecting member and ornament portion.

According to a further aspect of the present invention, a display device comprises: a dye sensitizing solar battery portion, which is a light transmittable and which is provided in a first area between a first light transmittable plate and a second light transmittable plate; and a liquid crystal portion, which is provided in a second area between the first light transmittable plate and the second light transmittable plate.

According to a further aspect of the present invention, a display device comprises: first and second light transmittable plates; an intermediate light transmittable plate, which is provided between the first and second light transmittable plates such that the first, intermediate and second light transmittable plates are arranged with predetermined intervals; a dye sensitizing solar battery portion, which is light transmittable and which is provided in one of the space between the first light transmittable plate and the intermediate light transmittable plate and the space between the intermediate light transmittable plate and the second light transmittable plate; and a liquid crystal portion, which is provided in the other of the space between the first light transmittable plate and the intermediate light transmittable plate and the space between the intermediate light transmittable plate and the second light transmittable plate.

According to a further aspect of the present invention, an electronic apparatus comprises: a dye sensitizing solar battery portion, which is light transmittable and which is provided in a first area between a first light transmittable plate and a second light transmittable pate; and a liquid crystal portion, which is provided in a second area between the first light transmittable plate and the second light transmittable pate; and an apparatus case, which houses the solar battery portion and the liquid crystal portion.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plane view of an analog wristwatch according to a first embodiment of the present invention;

FIG. 2 is a sectional view of the analog wristwatch of FIG. 1 taken along a line II-II in FIG. 1;

FIG. 3 is an enlarged sectional view of a main portion of an internal structure of the analog wristwatch shown in FIG. 2;

FIG. 4 is a schematic block diagram of an electric circuit of the analog wristwatch of FIG. 1;

FIG. 5 is a sectional view of an analog wristwatch according to a second embodiment of the present invention;

FIG. 6 is an enlarged sectional view of a main portion of an internal structure of the analog wristwatch shown in FIG. 5;

FIG. 7 is a sectional view of an analog wristwatch according to a third embodiment of the present invention;

FIG. 8 is an enlarged sectional view of a main portion of an internal structure of the analog wristwatch shown in FIG. 7;

FIG. 9 is a sectional view of an analog wristwatch according to a fourth embodiment of the present invention;

FIG. 10 is an enlarged sectional view of a main portion of an internal structure of the analog wristwatch shown in FIG. 9;

FIG. 11 is a sectional view of an analog wristwatch according to a fifth embodiment of the present invention;

FIG. 12 is an enlarged sectional view of a main portion of an internal structure of the analog wristwatch shown in FIG. 11;

FIG. 13 is a sectional view of an analog wristwatch according to a sixth embodiment of the present invention;

FIG. 14 is an enlarged sectional view of a main portion of an internal structure of the analog wristwatch shown in FIG. 13;

FIG. 15 is a sectional view of an analog wristwatch according to a seventh embodiment of the present invention;

FIG. 16 is an enlarged sectional view of a main portion of an internal structure of the analog wristwatch shown in FIG. 15;

FIG. 17 is a sectional view of an analog wristwatch according to an eighth embodiment of the present invention;

FIG. 18 is an enlarged sectional view of a main portion of an internal structure of the analog wristwatch shown in FIG. 17;

FIG. 19 is a plane view of an analog wristwatch according to a ninth embodiment of the present invention;

FIG. 20 is a sectional view of the analog wristwatch of FIG. 19 taken along a line XX-XX in FIG. 19;

FIG. 21 is an enlarged sectional view of a main portion of an internal structure of the analog wristwatch shown in FIG. 20;

FIG. 22 is a schematic block diagram of an electric circuit of the analog wristwatch shown in FIG. 19;

FIG. 23 is a plane view of a cellular phone according to a tenth embodiment of the present invention;

FIG. 24 is an enlarged sectional view of a main portion of an internal structure of the cellular phone of FIG. 23 taken along a line XXIV-XXIV in FIG. 23;

FIG. 25 is a plane view of an analog/digital wristwatch according to an eleventh embodiment of the present invention;

FIG. 26 is a sectional view of the analog/digital wristwatch of FIG. 25 taken along a line XXVI-XXVI in FIG. 25;

FIG. 27 is a plane view of a display device according to the eleventh embodiment of the present invention;

FIG. 28 is a sectional view of the display device taken along a line XXVIII-XXVIII in FIG. 27;

FIG. 29 is a sectional view of an analog/digital wristwatch according to a twelfth embodiment of the present invention;

FIG. 30 is a sectional view of an analog/digital wristwatch according to a thirteenth embodiment of the present invention;

FIG. 31 is a plane view of a display device according to a fourteenth embodiment of the present invention;

FIG. 32 is a sectional view of the display device of FIG. 31 taken along a line XXXII-XXXII in FIG. 31;

FIG. 33 is a sectional view of an analog/digital wristwatch according to a fifth embodiment of the present invention;

FIG. 34 is an enlarged sectional view of a display device of the analog/digital wristwatch of FIG. 33;

FIG. 35 is a sectional view of a display device according to a sixteenth embodiment of the present invention;

FIG. 36 is a sectional view of a display device according to a seventeenth embodiment of the present invention;

FIG. 37 is a sectional view of a display device according to an eighteenth embodiment of the present invention;

FIG. 38 is a plane view of an analog wristwatch according to a nineteenth embodiment of the present invention;

FIG. 39 is an enlarged sectional view of an ornament device of the analog wristwatch of FIG. 38;

FIG. 40 is a further enlarged sectional view of a main portion of the ornament device of FIG. 39; and

FIG. 41 is an enlarged sectional view of a main portion of a modification of the ornament device of FIG. 39.

### DETAILED DESCRIPTION OF THE INVENTION

[First Embodiment]

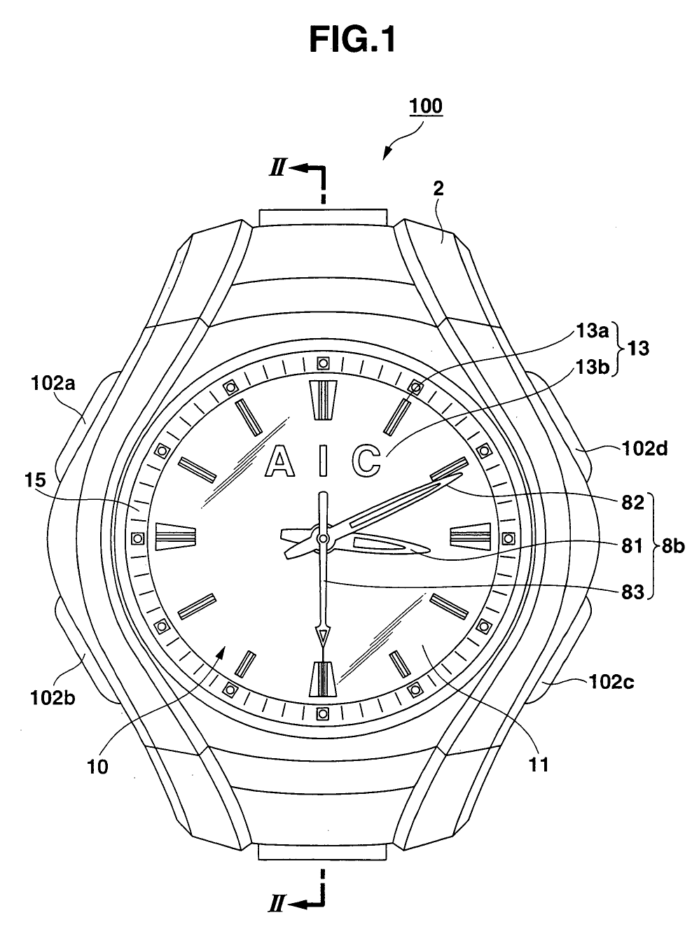

First, an analog wristwatch 100 according to a first embodiment of the invention will be explained in detail with reference to the accompanying drawings FIG. 1 to FIG. 4.

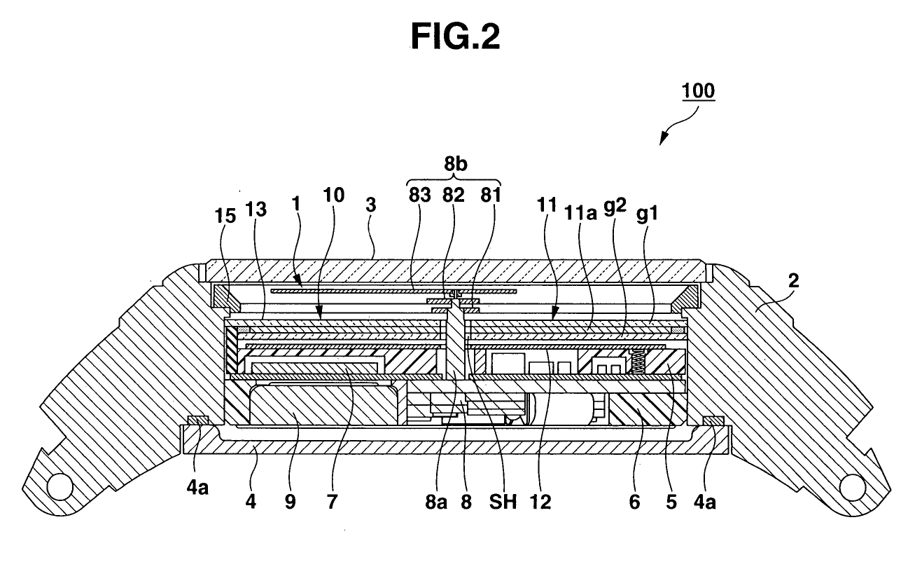

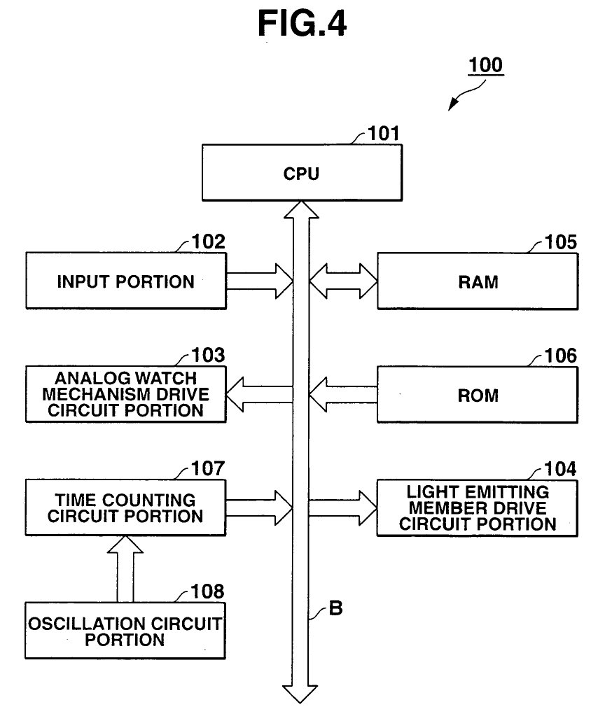

As shown in FIG. 1 and FIG. 2, the analog wristwatch 100 has a watch case 2 as an apparatus case having space for housing a watch unit 1. A watch glass 3 is fit in the opening of the housing space in the surface of the watch case 2. The opening of the housing space at the rear of the watch case 2 is closed by a rear cover 4 with a waterproof ring 4a. The rear cover is fixed to the rear side of the watch case 2 with screws (omitted in the drawings). At the periphery of the watch case 2, a plurality of switches 102a, 102b, 102c and 102d to execute various functions of the analog wristwatch 100 is provided. These switches 102a, 102b, 102c and 102d constitute an input portion 102 shown in FIG. 4.

As shown in FIG. 2, the watch unit 1 includes an upper housing 5 placed in the front side (hereinafter, called a sunlight incident side) of the watch case 2 in the housing space, a lower housing 6 placed opposite to the sunlight incident side (namely, the rear side of the watch case 2) with respect to the upper housing 5 in the housing space, and an ornament device 10 placed in the sunlight incident side (namely, the front side of the watch case 2) with respect to the upper housing 5 in the housing space.

A circuit board 7 such as a plastic wiring board is placed between the upper housing 5 and lower housing 6.

A frame member 15 is placed adjacent to the watch glass 3 at a location closer to the sunlight incident side than the watch unit 1 in the housing space.

The lower housing 6 includes an analog watch mechanism 8, and a secondary battery 9 which stores the power generated by a dye sensitizing solar battery 11 provided in the ornament device 10.

The analog watch mechanism 8 includes a plurality of coaxial hand shafts 8a extending to between the ornament device 10 and watch glass 3 through a shaft hole SH formed in the ornament device 10, and a group of hand group 8b including an hour hand 81, minute hand 82 and second hand 83 fixed to the respective ends of the hand shafts 8a. The analog watch mechanism 8 is electrically connected to the circuit board 7. The secondary battery 9 is also electrically connected to the circuit board 7.

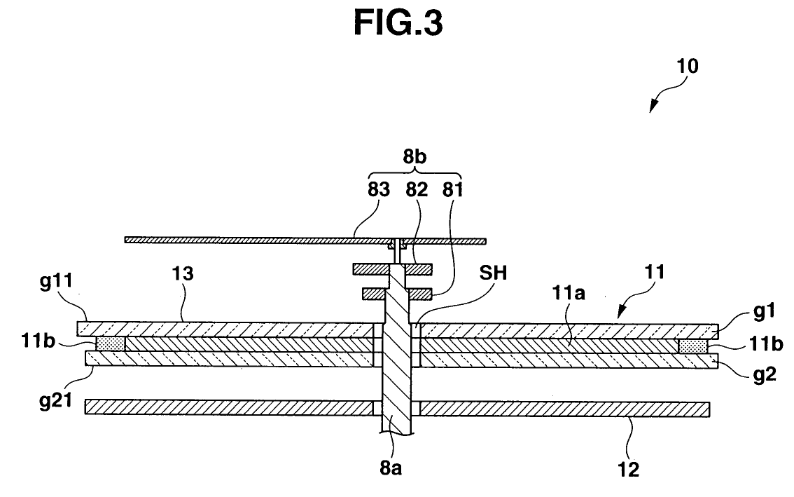

As shown in FIG. 2 and FIG. 3, the ornament device 10 has a dye sensitizing solar battery 11, an electroluminescence element 12 placed in the rear side of the solar battery 11 (opposite to the sunlight incident side) as a member to project light to the solar battery 11, and an ornament portion 13 placed in the front side of the solar battery 11 (in the sunlight incident side).

The dye sensitizing solar battery 11 includes an upper plate glass g1 and lower plate glass g2 forming a pair of light transmittable plates, and a dye sensitizing solar battery element 11a interposed between the upper plate glass g1 and lower plate glass g2.

The ornament portion 13 is printed on the outer surface g11 (the sunlight incident surface) of the upper plate glass g1. The ornament portion 13 includes a plurality of time marks 13a and a plurality of letters 13b, as shown in FIG. 1.

Each of the time marks 13a is a substantially rectangular figure in this embodiment, as shown in FIG. 1. The time marks 13a are printed at 12 locations spaced equally along the circumference at the periphery of the outer surface g11 (the sunlight incident surface) of the upper plate glass g1.

The letters 13b indicate the manufacturer or product name of the analog watch 100. In this embodiment, the letters 13b have three English letters A, I and C printed inside in the radial direction of the time marks 13a at the position corresponding to 12 o'clock on the outer surface g11 (the sunlight incident surface) of the upper plate glass g1, as shown in FIG. 1.

These time marks 13a and letters 13b are printed on the outer surface g11 of the upper plate glass g1 with non-light transmittable or semi-light transmittable paint, for example, and the light transmittance is different from the upper plate glass g1. Therefore, the user can visually and easily recognize the time marks 13a and letters 13b on the upper plate glass g11.

The time marks 13a and letters 13b can be printed on the outer surface g11 of the upper plate glass g1 by using several kinds of printing methods, thereby improving the visibility and design.

The dye sensitizing solar battery element 11a includes a plurality of not-shown upper light transmittable electrodes provided on the inner surface of the upper glass g1, a plurality of not-shown lower light transmittable electrodes provided on the inner surface of the lower plate glass g2, a not-shown metal oxide layer which is absorbed with a predetermined dye and sealed by a sealing member 11b between the upper plate glass g1 and lower plate glass g2, and a not-shown electric charge transfer layer which has a predetermined electrolyte and sealed by the sealing member 11b together with the metal oxide layer between the upper plate glass g1 and lower plate glass g2.

As the above dye, for example, a ruthenium complex (RuL₂(NCS)₂, L=4.4′-dicarboxy-2.2′ bipyridine) can be used. As the metal oxide to absorb this dye, a titanium oxide (TiO₂) can be used. As the above electrolyte, for example, an iodide, such as a lithium iodide and metal iodine can be used. The electric charge transfer layer can be formed by adding the lithium iodine or metal iodine to polyethylene glycol, for example.

External light, such as sunlight, the light from an indoor lamp or outdoor lamp is projected to the dye sensitizing solar battery 11 through the watch glass 3.

The dye sensitizing solar battery 11 is light transmittable, and can transmit the light emitted from the electroluminescence element 12 placed opposite to the sunlight incident side with respect to the dye sensitizing solar battery 11, to the sunlight incident side of the dye sensitizing solar battery 11.

When light is projected to the dye sensitizing solar battery 11, the dye absorbed in the metal oxide (not shown) absorbs the optical energy, and the metal oxide layer (not shown) emits an electron. The emitted electron is moved to one light transmittable electrode through the electric charge transfer layer (not shown), and sent to the other light transmittable electrode passing through a predetermined external load resistor (e.g., the analog watch mechanism 8 of the time counting portion 1 of the watch), and then returned to the metal oxide layer (not shown) through the electric charge transfer layer (omitted). The dye sensitizing solar battery 11 generates a current by circulating an electron as described above, and supplies electric energy to the load resistor.

FIG. 4 shows the schematic block diagram of the electric circuit on the circuit board 7 of the analog wristwatch 100. The electric circuit has a CPU 101, an input portion 102, an analog watch mechanism driving circuit portion 103, a light-emitting member driving circuit portion 104, a RAM 105, a ROM 106, a time counting circuit portion 107, and an oscillation circuit portion 108. The CPU 101, input portion 102, analog watch mechanism driving circuit portion 103, light-emitting member driving circuit portion 104, RAM 105, ROM 106 and time counting circuit portion 107 are connected via a bus B. The oscillation circuit portion 108 is connected to the time counting circuit portion 107.

The CPU 101 issues an instruction and transfers data to each function unit based on the programs stored in the ROM 106, at a predetermined timing or by the control signal inputted from the input portion 102. The CPU 101 outputs the time signal based on the current time data counted by the time counting circuit portion 107 to the analog watch mechanism driving circuit portion 103, specifies one of the time marks 13a of the ornament portion 13 of the ornament device 10 by one of the hour hand 81, minute hand 82 and second hand 83 of the analog watch mechanism driving circuit portion 103, and displays the current time.

The input portion 102 includes a plurality of switches 102a, 102b, 102c and 102d (refer to FIG. 1) which are provided at the periphery of the watch case 2 and used to execute the functions of the analog wristwatch 100 as described above. When the switches 102a, 102b, 102c and 102d are operated, the control signal of the operated switch is outputted to the CPU 101.

The analog watch mechanism driving circuit portion 103 forms a portion of the analog watch mechanism 8. When the time signal based on the current time data counted by the time counting circuit portion 107 is inputted to the CPU 101 as described above, the circuit portion 103 causes the analog watch mechanism 8 to indicate one of the time marks 13a of the ornament portion 13 of the ornament device 10 by one of the hour hand 81, minute hand 82 and second hand 83, and display the current time.

The light-emitting member driving circuit portion 104 outputs a light emitting signal to the electroluminescence element 12 based on the output instruction signal sent from the CPU 101, and makes the electroluminescence element 12 emit light toward the ornament portion 13 of the dye sensitizing solar battery 11.

The RAM 105 temporarily stores the data processed by the CPU 101 under the control of CPU 101. The ROM 106 stores mainly the system program related to the analog wristwatch 100.

The oscillation circuit portion 108 always outputs a constant frequency signal. The time counting circuit portion 107 counts the signal from the oscillation circuit portion 108, obtains the current time data, and outputs the current time data to the CPU 101.

Next, explanation will be given on the operation of the analog wristwatch 100 configured as described above.

When sunlight or the external light from an indoor lamp or outdoor lamp is projected to the upper plate glass g1 of the dye sensitizing solar battery 11 through the watch glass 3, the dye sensitizing solar battery element 11a performs photoelectric conversion. The current obtained by the photoelectric conversion is once stored in the secondary battery 9.

The above electric circuit of the analog wristwatch 100 is driven by the current from the secondary battery 9.

When the analog watch mechanism driving circuit portion 103 of the analog watch mechanism 8 receives from the CPU 101 the time signal based on the current time data counted by the time counting circuit portion 107, the analog watch mechanism 8 displays the current time by pointing out any one of the time marks 13a of the ornament portion 13 of the ornament device 10 by the hour hand 81, minute hand 82 and second hand 83.

Under sunlight or the external light from an indoor lamp or outdoor lamp, the user can visually recognize the current time displayed by pointing out any one of the time marks 13a of the ornament portion 13 of the ornament device 10 by the hour hand 81, minute hand 82 and second hand 83, and the letters 13b of the ornament portion 13 through the watch glass 3a, through the watch glass 3a.

When the user presses one of the switches 102a, 102b, 102c and 102d related to ON/OFF of the electroluminescence element 12 in the input portion 102 (refer to FIG. 1) at night, in cloudy weather or in a dark place, the CPU 101 outputs an output instruction signal to the light-emitting member driving circuit portion 104 (refer to FIG. 4). Receiving the output instruction signal, the light-emitting member driving circuit portion 104 (refer to FIG. 4) outputs a light emitting signal to the electroluminescence element 12. Receiving the light emitting signal, the electroluminescence element 12 emits light toward the dye sensitizing solar battery 11 by the power stored in the secondary battery 9. By the light from the electroluminescence element 12 passing through the dye sensitizing solar battery 11, the user can visually recognize the time marks 13a of the ornament portion 13 on the outer surface g11 of the upper plate glass g1 of the dye sensitizing solar battery 11, and the hour hand 81, minute hand 82 and second hand 83 of the analog watch mechanism 8. Namely, the user can know the current time by the recognized time marks 13a and the hour hand 81, minute hand 82 and second hand 83 of the analog watch mechanism 8. At the same time, the user can visually recognize the letters 13b of the ornament portion 13.

While the light from the electroluminescence element 12 is passing through the dye sensitizing solar battery 11, a portion of the light is absorbed by the dye of the dye sensitizing solar battery element 11a and converted into electric current by the solar battery element 11a. The current generated by the photoelectric conversion is also stored in the secondary battery 9.

As explained above in detail with reference to FIG. 1 to FIG. 4, in the analog wristwatch 100 according to a first embodiment, the dye sensitizing solar battery 11 exposed to the whole surface of the opening of the sunlight incident side in the housing space of the watch case 2 can generate sufficient electricity from the sunlight entered from the opening of the sunlight incident side or the external light from an indoor lamp or outdoor lamp, and can also generate electric power from a portion of the light emitted from the electroluminescence element 12 when light is emitted from the electroluminescence element 12 placed opposite to the sunlight incident side with respect to the dye sensitizing solar battery 11 in the housing space. Therefore, compared with the conventional case that a light-emitting member and a solar battery are placed on the same plane, the dye sensitizing solar battery 11 can generate increased electric energy.

Further, as the electroluminescence element 12 (light-emitting member) is placed opposite to the sunlight incident side with respect to the dye sensitizing solar battery 11, compared with the conventional case that a light-emitting member and a solar battery are placed on the same plane, the electroluminescence 12 (light-emitting member) can obtain a wider light-emitting area and emit increased amount of light.

When the electroluminescence element 12 emits light in a dark place, the dye sensitizing solar battery 11 generates electric power from a portion of the light emitted from the electroluminescence element 12, and the generated electric power is stored in the secondary battery 9. Namely, a portion of the power consumed by the electroluminescence element 12 is collected by the dye sensitizing solar battery 11, and the power consumption when the electroluminescence element 12 emits light can be decreased.

Further, the light emitted from the electroluminescence element 12 penetrates through the whole surface of the dye sensitizing solar battery 11 of the ornament device 10. Therefore, when the electroluminescence element 12 emits light in a dark place, the light from the electroluminescence element 12 can light up all of the time marks 13a and letters 13b (AIC) of the ornament portion 13 on the outer surface g11 of the upper plate glass g1 of the dye sensitizing solar battery 11, and hour hand 81, minute hand 82 and second hand 83. This improves the visibility of the ornament portion 13 in a dark place.

As the time marks 13a and letters 13b of the ornament portion 13 are directly printed on the outer surface g11 of the upper plate glass g1 of the dye sensitizing solar battery 11, it is unnecessary to make a separate ornament plate with various ornaments including time marks and letters, and combine it with the dye sensitizing solar battery 11. This can make the ornament device 10 thin, and make the analog wristwatch 100 thin.

The position to provide the ornament portion 13 is not limited to the outer surface g11 of the upper plate glass g1 of the dye sensitizing solar battery 11. The ornament portion may be provided on the outer surface g21 of the lower plate glass g2 (the surface opposite to the electroluminescence element 12) of the dye sensitizing solar battery 11, or on both of the outer surface g11 of the upper plate glass g1 and the outer surface g21 of the lower plate glass g2.

The ornament portion 13 can include various desired patterns such as radial, concentric and grid patterns in addition to the letters 13b and figures like the time marks 13a.

As the simple time marks are provided on the surface opposite to the watch glass 3 in the frame member 15 right under the watch glass 3 as shown in FIG. 1, the user can know the current time also by the combination of the time marks and the hour hand 81, minute hand 82 and second hand 83, as long as the user is in a light place.

[Second Embodiment]

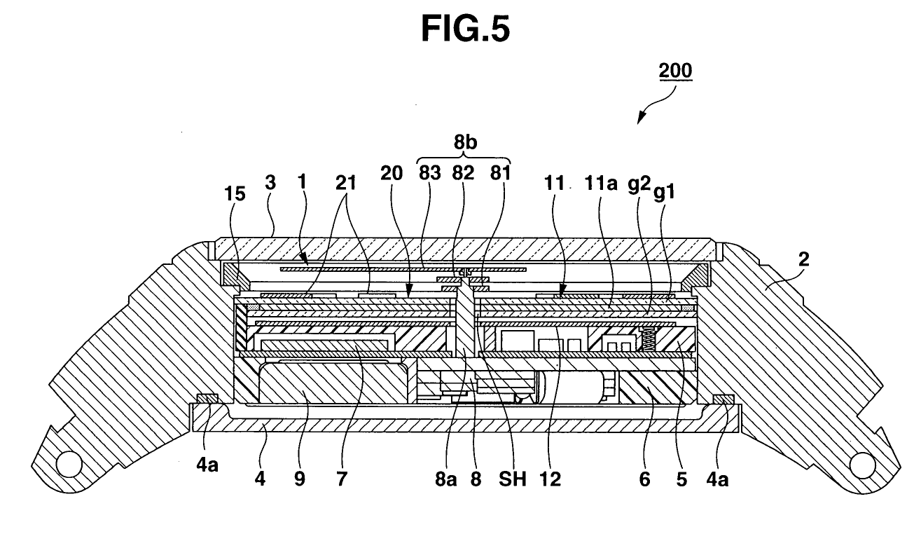

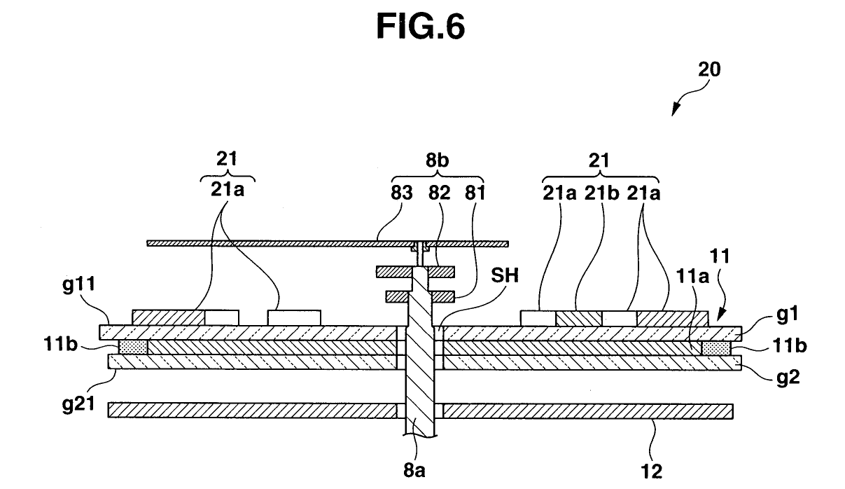

Next, an explanation will be given on an analog wristwatch 200 according to a second embodiment of the present invention with reference to FIG. 5 and FIG. 6.

Most components of the analog wristwatch 200 of the second embodiment are the same as the analog wristwatch 100 according to the first embodiment described above with reference to FIG. 1 to FIG. 4. Therefore, in the description of the analog wristwatch 200 according to the second embodiment, the same reference numerals are given to the same components as those of the wristwatch 100 of the first embodiment, and a detailed explanation will be omitted.

Only an ornament device 20 of the analog wristwatch 200 of the second embodiment is different from the analog wristwatch 100 of the first embodiment.

As shown in FIG. 5, the ornament device 20 of the analog wristwatch 200 includes ornament portion 21 fixed to the outer surface g11 of the upper plate glass g1 of the dye sensitizing solar battery 11.

More concretely, as shown well in FIG. 6, the ornament portion 21 has time marks 21a and letters 21b formed independently of the upper plate glass g1. These time marks 21a and letters 21b are fit at predetermined positions on the outer surface g11 of the upper plate glass g1 and projected far from the outer surface g11 toward the watch glass 3.

Each of the time marks 21a is made of substan- tially rectangular metal stick member, for example. Like the time marks 13a of the ornament portion 13 of the ornament device 10 of the first embodiment shown in FIG. 1, the time marks 21a are provided at 12 locations spaced equally along the circumference at the periphery of the outer surface g11 (the sunlight incident surface) of the upper plate glass g1.

The letters 21b are made of metal members shaped like three English letters A, I and C. Like the letters 13b of the ornament portion 13 of the ornament device 10 of the first embodiment shown in FIG. 1, the letters 21b indicate the manufacturer or product name of the analog watch 200, for example, and are fixed to the inside of the radial direction of the time marks 21a at the position corresponding to 12 o'clock on the outer surface g11 (sunlight incident surface) of the upper plate glass g1 by a well-know fixing means such as an adhesive.

As described above in detail, in the analog wristwatch 200 according to the second embodiment, the independently formed time marks 21a and letters 21b of the ornament portion 21 of the ornament device 20 are fixed to the outer surface g11 of the upper plate glass g1 of the dye sensitizing solar battery 11. This makes the ornament portion more effective compared with the time marks 13a and letters 13b of the ornament portion 13 of the ornament device 10 of the first embodiment printed on the outer surface g11 of the upper plate glass g1 of the dye sensitizing solar battery 11.

It is also possible to make all or some of the time marks 21a and letters 21b by using a shell such as white butterfly, or a pyroxene like an opal, and improves the quality, especially the quality appearance of the ornament portion 21 of the ornament device 20.

The time marks 21a are not limited to the stick- shaped. They may be made of members shaped circular or other various shapes, or members shaped like numerals including Arabic and Roman numerals.

The means for fixing the time marks 21a and letters 21b of the ornament portion 21 to the outer surface g11 of the upper plate glass g1 of the dye sensitizing solar battery 11 is not limited to the above-mentioned adhesive. The fixing method may also be either manually or automatically.

The time marks 21a and letters 21b can be made of light transmittable material. However, it is preferable to use non-light transmittable material, such as, a metal to increase luster to permit the user to visually recognize the time marks 21a and letters 21b in a dark plate by the light emitted from the electroluminescence element 12 placed opposite to the sunlight incident side of the dye sensitizing solar battery 11 and transmitted through the dye sensitizing solar battery.

The ornament portion 21 can include various patterns such as radial, concentric and grid patterns in addition to the letters 21b and figures like the time marks 21a.

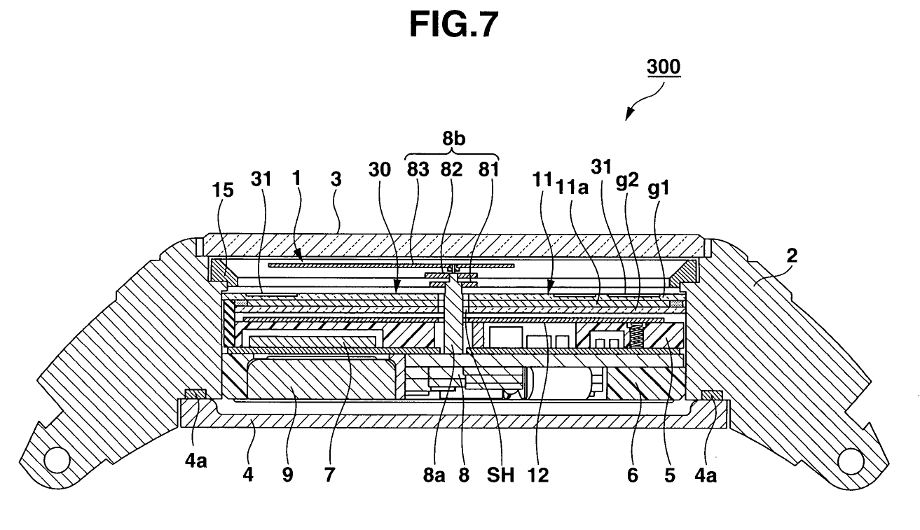

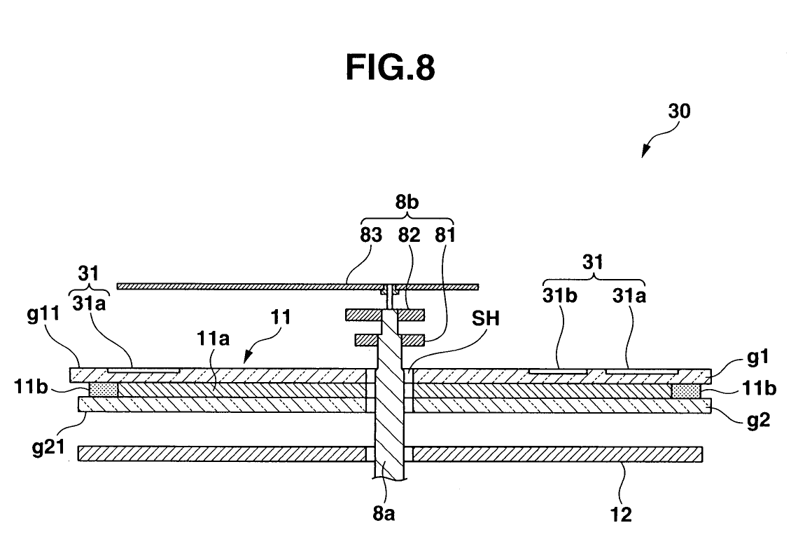

The ornament portion 21 are fixed to the outer surface g11 of the upper plate glass g1 of the dye sensitizing solar battery 11, but the fixing position of the ornament portion 21 is not limited to this. For example, the ornament portion 21 may be fixed to the outer surface g21 of the lower plate glass g2 (the surface opposite to the electroluminescence element 12), and may be fixed to both of the outer surface g11 of the upper plate glass g1 and the outer surface g21 of the lower plate glass g2. [Third Embodiment] Now, an explanation will be given on an analog wristwatch 300 according to a third embodiment of the present invention with reference to FIG. 7 and FIG. 8.

Most components of the analog wristwatch 300 of the third embodiment are the same as the analog wristwatch 100 according to the first embodiment described before with reference to FIG. 1 to FIG. 4. Therefore, in the description of the analog wristwatch 300 according to the third embodiment, the same reference numerals are given to the same components as those of the wristwatch 100 of the first embodiment, and a detailed explanation will be omitted.

Only an ornament device 30 of the analog wristwatch 300 of the third embodiment is different from the analog wristwatch 100 of the first embodiment.

The ornament device 30 includes a plurality of ornament portions 31 formed by etching on the outer surface g11 of the upper plate glass g1 of the dye sensitizing solar battery 11.

The ornament portions 31 have a plurality of time marks 31a and letters 31b formed by etching at predetermined positions on the outer surface g11 of the upper plate glass g1.

The above predetermined positions are the same as those of the time marks 13a and letters 13b of the ornament portion 13 fixed to the outer surface g11 of the upper plate glass g1 in the first embodiment.

Etching for forming the ornament portion 31 on the outer surface g11 of the upper plate glass g1 is performed as follows. First, apply a resist to the portions of the outer surface g11 of the upper plate glass g1 except for the portions corresponding to the time marks 31a and letters 31b, and form the planes of time marks 31a and letters 31b surrounded by the film of applied resist in the above-mentioned corresponding portions. Then, immerse the upper plate glass g1 with the applied resist film in the etching solution, and remove the portions not covered by the applied resist film by the etching solution. Lastly, raise the upper plate glass g1 covered by the applied resist film from the etching solution, eliminate the resist from the upper plate glass g1, and rinse the upper plate glass g1.

The ornament portion 31 formed by etching on the outer surface g11 of the upper plate glass g1 glows uniquely when projected by external light or the light transmitted through the electroluminescence element 12, and increases the effect of the ornament portion 31.

The shapes of the time marks 31a and letters 31b of the ornament portion 31 are not limited to the concave formed by etching on the outer surface g11 of the upper glass g1 as described above. The time marks 31a and letters 31b may be formed convex on the outer surface g11 of the upper plate glass g1 by etching the portions except for the time marks 31a and letters 31b on the outer surface g11 of the upper plate glass g1, for example.

The position to form the ornament portion 31 by etching is not limited to the outer surface g11 of the upper plate glass g1. The ornament portion 31 can be formed by etching on the outer surface g21 of the lower plate glass g2 (the surface opposite to the electroluminescence element 12), or on both of the outer surface g11 of the upper plate glass g1 and the outer surface g21 of the lower plate glass g2.

The ornament portion 31 can include various patterns such as radial, concentric, and grid patterns in addition to the letters 31b and figures like the time marks 31a.

[Fourth Embodiment]

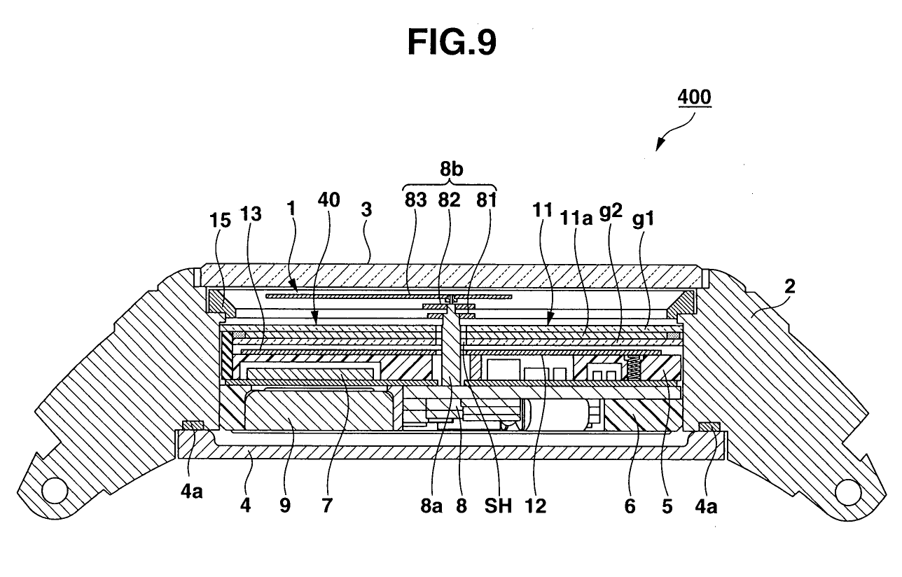

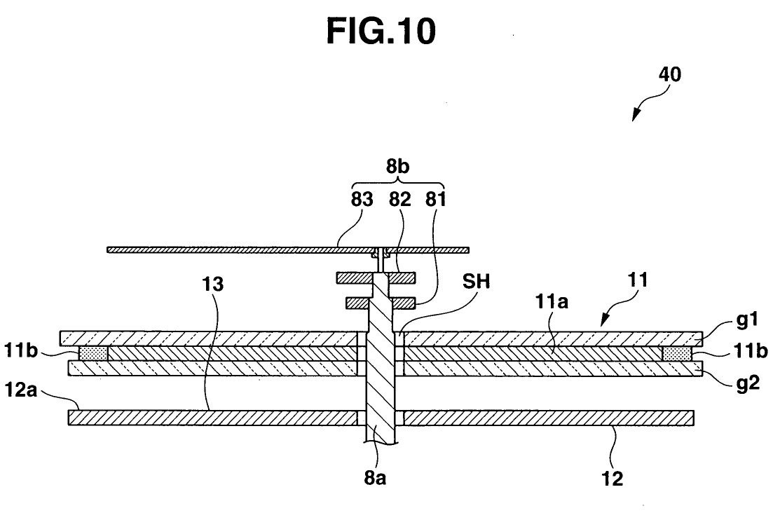

Now, an explanation will be given on an analog wristwatch 400 according to a fourth embodiment of the present invention with reference to FIG. 9 and FIG. 10.

Most components of the analog wristwatch 400 of the third embodiment are the same as the analog wristwatch 100 according to the first embodiment described above with reference to FIG. 1 to FIG. 4. Therefore, in the description of the analog wristwatch 400 according to the fourth embodiment, the same reference numerals are given to the same components as those of the wristwatch 100 of the first embodiment, and a detailed explanation will be omitted.

Only an ornament device 40 of the analog wristwatch 400 of the fourth embodiment is different from the analog wristwatch 100 of the first embodiment.

As shown in FIG. 9 and FIG. 10, in the ornament device 40, the ornament portion 13 (time marks 13a and letters 13b) similar to the ornament portion 13 in the first embodiment described with reference to FIG. 1 to FIG. 4 are printed at predetermined positions on the projected outer surface 12a opposite to the dye sensitizing solar battery 11 in the electroluminescence element 12 as a light-projecting member.

In the fourth embodiment, all the external light entered through the watch glass 3 and almost all the light emitted from the electroluminescence element 12 are projected to the whole surface of the upper plate glass g1 and lower plate glass g2 of the dye sensitizing solar battery 11 without interrupted or attenuated by the ornament device 40. Therefore, the ornament device 40 of the fourth embodiment increases the power generating capacity of the dye sensitizing solar battery 11, compared with the first embodiment in which the ornament portion 13 are printed on at least one of the outer surface g11 of the upper glass g1 and the outer surface g21 of the lower plate glass g2, the second embodiment in which the ornament portion 21 is fixed to at least one of the outer surface g11 of the upper plate glass g1 and the outer surface g21 of the lower plate glass g2, and the third embodiment in which the ornament portion 31 is formed by etching on at least one of the outer surface g11 of the upper plate glass g1 and the outer surface g21 of the lower plate glass g2.

The light emitted from the electroluminescence element 12 projects the shadows of the ornament portion 13 of the ornament device 40 on the outer surface g11 of the upper plate glass g1 of the dye sensitizing solar battery 11. Thus, the user can visually recognize the shadows of the ornament portion 13 on the outer surface g11 of the upper plate glass g1 of the dye sensitizing solar battery 11 very well especially in a dark place. Of course, even in a light place, the user can visually recognize the shadows of the ornament portion 13 on the outer surface g11 of the upper plate glass g1 of the dye sensitizing solar battery 11 by emitting light from the electroluminescence element 12.

The ornament portion 13 printed directly on the electroluminescence element 12 eliminates the necessity of an ornament plate formed independently and incorporated independently in the watch unit 1, making the ornament device 40 thin. As a result, the analog wristwatch 400 can be made thin.

[Fifth Embodiment]

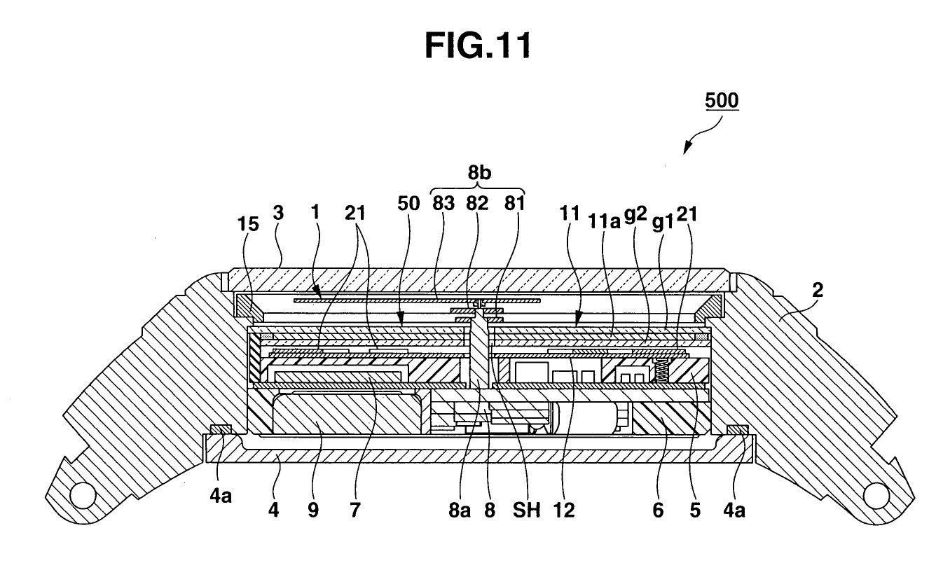

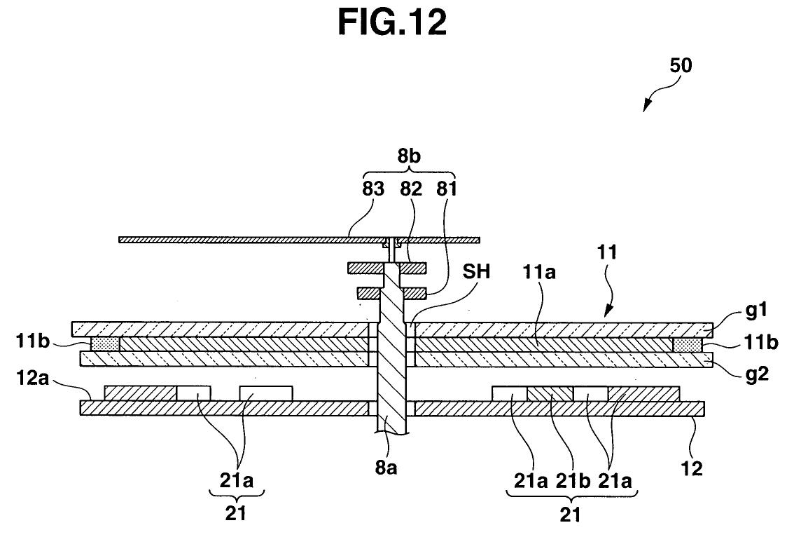

Now, an explanation will be given on an analog wristwatch 500 according to a fifth embodiment of the present invention with reference to FIG. 11 and FIG. 12.

Most components of the analog wristwatch 500 of the fifth embodiment are the same as the analog wristwatch 100 according to the first embodiment described above with reference to FIG. 1 to FIG. 4. Therefore, in the description of the analog wristwatch 500 according to the fifth embodiment, the same reference numerals are given to the same components as those of the wristwatch 100 of the first embodiment, and a detailed explanation will be omitted.

Only an ornament device 50 of the analog wristwatch 500 of the fifth embodiment is different from the analog wristwatch 100 of the first embodiment.

As shown in FIG. 11 and FIG. 12, in the ornament device 50, the ornament portion 21 (time marks 21a and letters 21b) formed independently similar to the ornaments 21 in the second embodiment described with reference to FIG. 5 and FIG. 6 is fixed at predetermined positions on the projected outer surface 12a opposite to the dye sensitizing solar battery 11 in the electroluminescence element 12 as a light-projecting member.

In the fifth embodiment, all the external light entered through the watch glass 3 and almost all the light emitted from the electroluminescence element 12 are projected to the whole surface of the upper plate glass g1 and lower plate glass g2 of the dye sensitizing solar battery 11 without interrupted or attenuated by the ornament device 50. Therefore, the ornament device 50 of the fifth embodiment increases the power generating capacity of the dye sensitizing solar battery 11, compared with the first embodiment in which the ornament portion 13 are printed on at least one of the outer surface g11 of the upper glass g1 and the outer surface g21 of the lower plate glass g2, the second embodiment in which the ornament portion 21 is fixed to at least one of the outer surface g11 of the upper plate glass g1 and the outer surface g21 of the lower plate glass g2, and the third embodiment in which the ornament portion 31 is formed by etching on at least one of the outer surface g11 of the upper plate glass g1 and the outer surface g21 of the lower plate glass g2.

The light emitted from the electroluminescence element 12 projects the shadow of the ornament portion 21 of the ornament device 50 on the outer surface g11 of the upper plate glass g1 of the dye sensitizing solar battery 11. Thus, the user can visually recognize the shadow of the ornament portion 21 on the outer surface g11 of the upper plate glass g1 of the dye sensitizing solar battery 11 very well especially in a dark place. Of course, even in a light place, the user can visually recognize the shadow of the ornament portion 21 on the outer surface g11 of the upper plate glass g1 of the dye sensitizing solar battery 11 by emitting light from the electroluminescence element 12.

The ornament portion 21 formed independently and fixed to the electroluminescence element 12 eliminates the necessity of an ornament plate formed independently and incorporated independently in the watch unit 1, making the ornament device 50 thin. As a result, the analog wristwatch 500 can be made thin.

[Sixth Embodiment]

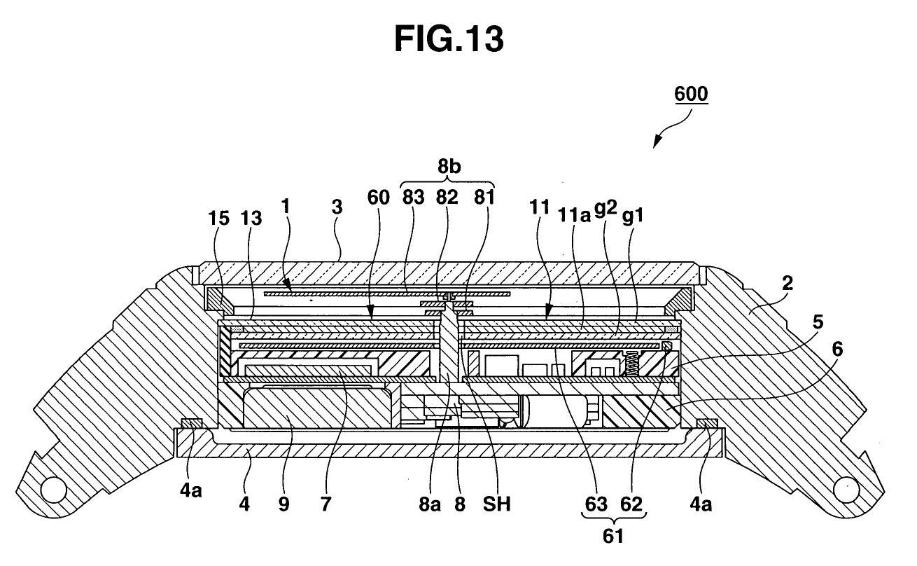

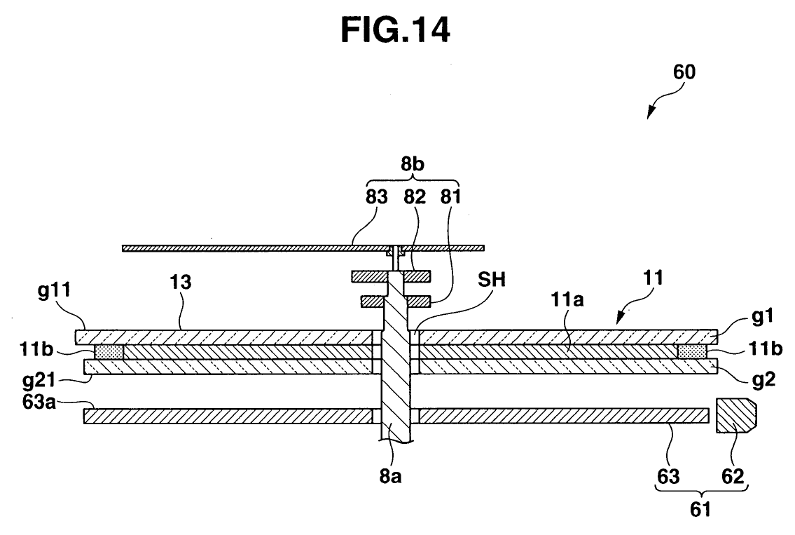

Now, an explanation will be given on an analog wristwatch 600 according to a sixth embodiment of the present invention with reference to FIG. 13 and FIG. 14.

Most components of the analog wristwatch 600 of the sixth embodiment are the same as the analog wristwatch 100 according to the first embodiment described above with reference to FIG. 1 to FIG. 4. Therefore, in description of the analog wristwatch 600 according to the fifth embodiment, the same reference numerals are given to the same components as those of the wristwatch 100 of the first embodiment, and a detailed explanation will be omitted.

Only an ornament device 60 of the analog wristwatch 600 of the fifth embodiment is different from the analog wristwatch 100 of the first embodiment.

Like the ornament portion 13 of the ornament device 10 of the analog wristwatch 100 of the first embodiment described above with reference to FIG. 1 to FIG. 4, the ornament device 60 includes the ornament portion 13 (time marks 13a and letters 13b) printed at predetermined positions on the outer surface g11 of the upper plate glass g1 of the dye sensitizing solar battery 11.

However, the ornament device 60 includes a light-projecting member 61 instead of the electroluminescence element 12 as a light-projecting member of the ornament device 10 of the analog wristwatch 100 of the first embodiment described before. The light-projecting member includes a light guide plate 63 placed at the same position as the electroluminescence element 12, and a LED 62 as a light-emitting element placed opposite to the periphery of the light guide plate 63.

More concretely, the LED 62 is placed opposite to one of the positions corresponding to twelve o'clock of the time marks 13a of the ornament portion 13 on the periphery of the light guide plate 63, for example. The light emitted from the LED 62 and applied to the light guide plate 63 is ejected toward the dye sensitizing solar battery 11 from the whole surface of the light guide plate 63 opposite to the dye sensitizing solar battery 11.

The LED 62 is electrically connected to the light-emitting member driving circuit portion 104 in the electric circuit shown in FIG. 4, and emits light to the light guide plate 63 based on the light emitting signal outputted from the light-emitting member driving circuit portion 104.

In the analog wristwatch 600 of the sixth embodiment, the light emitted from the LED 62 is ejected toward the dye sensitizing solar battery 11 from the whole surface of the light guide plate 63 opposite to the dye sensitizing solar battery 11, and the light from the light guide plate 63 is evenly projected to the whole surface of the lower plate glass g2 of the dye sensitizing solar battery 11. Therefore, the light-projecting member 61 including the LED 62 and light guide plate 63 in the ornament device 60 of the analog wristwatch 600 of the sixth embodiment serves like the electroluminescence element 12 as a light-projecting member of the analog wristwatch 100 of the first embodiment.

In the sixth embodiment, the LED 62 is placed only at the position of twelve o'clock with respect to the periphery of the light guide plate 63, but it is permitted to arrange more than one LED 62 circularly at given intervals or continuously just like a ring around the periphery of the light guide plate 63.

The place to print the ornament portion 13 is not limited to the outer surface g11 of the upper plate glass g1. It is permitted to print on the outer surface g21 of the lower plate glass g2 (the surface opposite to the light guide plate 63 of the light-emitting member 61), for example. It is also possible to print on both of the outer surface g11 of the upper plate glass g1 and the outer surface g21 of the lower plate glass g2.

It is possible to fix the ornament 21 of the second embodiment described with reference to FIG. 5 and FIG. 6 to one or both of the outer surface g11 of the upper plate glass g1 and the outer surface g21 of the lower plate glass g2, instead of the ornament portion 13 printed on the outer surface g11 of the upper plate glass g1. It is possible to form by etching the ornament portion 31 of the third embodiment described with reference to FIG. 7 and FIG. 8 to one or both of the outer surface g11 of the upper plate glass g1 and the outer surface g21 of the lower plate glass g2.

The ornament portion 13 can also be printed on the surface 63a of the light guide plate 63 opposite to the lower plate glass g2 of the dye sensitizing solar battery 11. Instead of the ornament portion 13 formed by printing, it is possible to fix the ornament portion 21 of the second embodiment described with reference to FIG. 5 and FIG. 6 to the surface 63a of the light guide plate 63 opposite to the solar battery. It is also possible to form by etching the ornament portion 31 of the third embodiment described with reference to FIG. 7 and FIG. 8 on the surface 63a of the light guide plate 63 opposite to the solar battery.

[Seventh Embodiment]

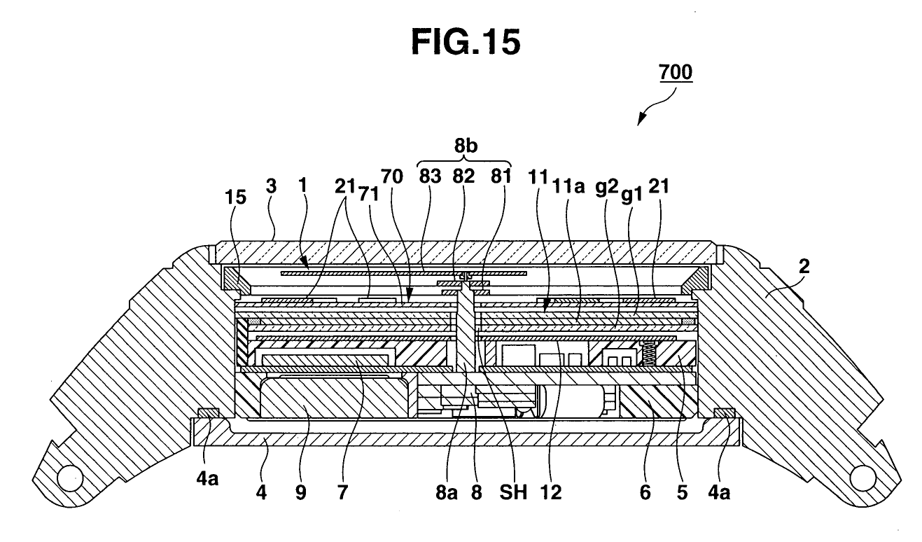

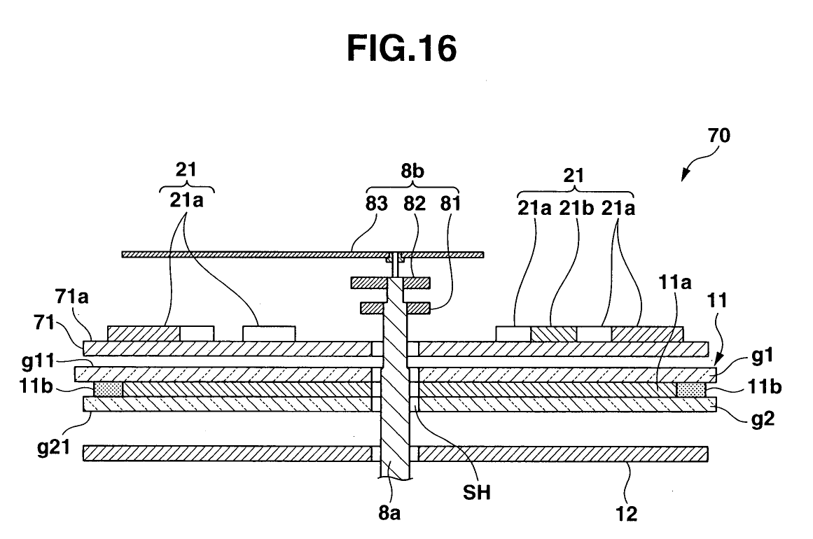

Now, an explanation will be given on an analog wristwatch 700 according to a seventh embodiment of the present invention with reference to FIG. 15 and FIG. 16.

Most components of the analog wristwatch 700 of the sixth embodiment are the same as the analog wristwatch 100 according to the first embodiment described above with reference to FIG. 1 to FIG. 4. Therefore, in the description of the analog wristwatch 700 according to the seventh embodiment, the same reference numerals are given to the same components as those of the wristwatch 100, and a detailed explanation will be omitted.

Only an ornament device 70 of the analog wristwatch 700 of the seventh embodiment is different from the analog wristwatch 100 of the first embodiment.

The ornament device 70 is placed between the dye sensitizing solar battery 11 and the hand group 8b, and includes an ornament plate 71, which is light transmittable. On the surface 71a of the ornament plate 71 opposite to the watch glass 3, the ornament portion 21 formed independently is fixed just like the ornament portion 21 of the analog wristwatch 200 of the second embodiment described with reference to FIG. 5 and FIG. 6.

The ornament plate 71 has a through hole, in which a plurality of hand shafts 8a is inserted. The outer periphery of the ornament plate 71 is fixed to a predetermined position of the inner circumference of the housing space of the watch case 2.

The color of the ornament plate 71 is different from the color of the dye of the dye sensitizing solar battery element 11a of the dye sensitizing solar battery 11. Therefore, when viewing the light transmittable ornament plate 71 through the watch glass 3, the user recognizes the composite color made by the colors of the ornament plate 71 and the dye of the dye sensitizing solar battery element 11a.

Like the ornament portion 21 of the analog wristwatch 200 of the second embodiment described with reference to FIG. 5 and FIG. 6, the ornament portion 21 include time marks 21a and letters 21b.

As the ornament plate 71 is light transmittable, a very small portion of the external light coming into the housing space of the watch case 2 through the watch glass 3 is interrupted by the ornament portion 21, but almost all of the external light can reach the whole surface of the upper plate glass g1 of the dye sensitizing solar battery 11 through the ornament plate 71.

All the light emitted from the electroluminescence element 12 reaches the whole surface of the lower plate glass g2 of the dye sensitizing solar battery 11.

Therefore, when the analog wristwatch 700 of the seventh embodiment is used under external light either by emitting or without emitting light from the electroluminescence element 12, the dye sensitizing solar battery 11 can efficiently generate much electric power.

By changing the color of the ornament plate 71, the composite color made by the colors of the ornament plate 71 and the dye of the dye sensitizing solar battery element 11a can be varied and the effect of the ornament portion can be changed.

The position to fix the ornament portion 21 is not limited to the ornament plate 71. The ornament portion 21 can be fixed to the outer surface g11 of the upper plate glass g1 of the dye sensitizing solar battery 11, or the outer surface g21 of the lower plate glass g2 (the surface opposite to the electroluminescence element 12), or both of the outer surface g11 of the upper glass g1 and the outer surface g21 of the lower plate glass. It is also possible to fix to the surface of the electroluminescence element 12 opposite to the dye sensitizing solar battery 11.

Instead of the ornament portion 21 fixed to the ornament plate 71, it is possible to print the ornament portion 13 of the first embodiment described with reference to FIG. 1 to FIG. 4 on the ornament plate 71, one or both of the outer surface g11 of the upper plate glass g1 and the outer surface g21 of the lower plate glass g1 of the dye sensitizing solar battery 11. It is also possible to print on the surface of the electroluminescence element 12 opposite to the dye sensitizing solar battery 11. It is also possible to form by etching the ornament portion 31 of the third embodiment described with reference to FIG. 7 and FIG. 8 on the ornament plate 71, one or both of the outer surface g11 of the upper plate glass g1 and the outer surface g21 of the lower plate glass 2 of the dye sensitizing solar battery 11.

[Eighth Embodiment]

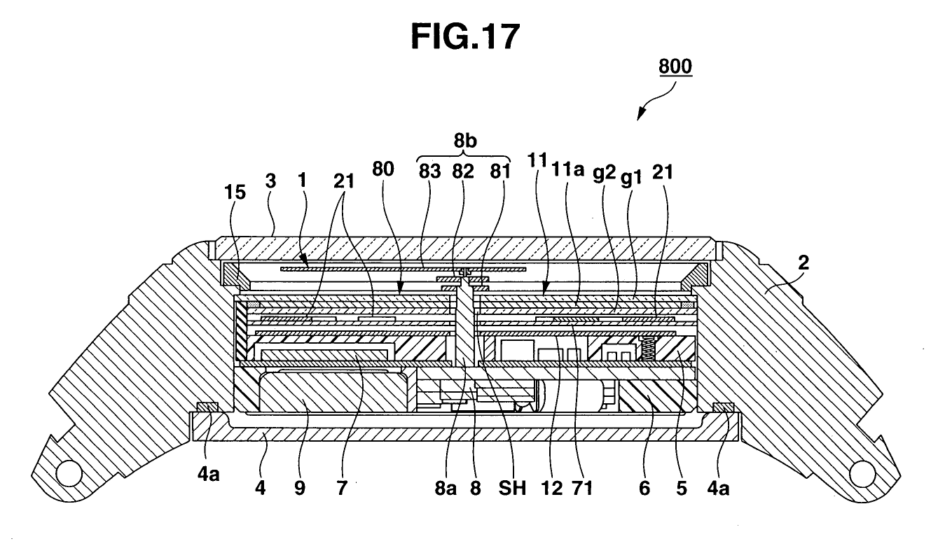

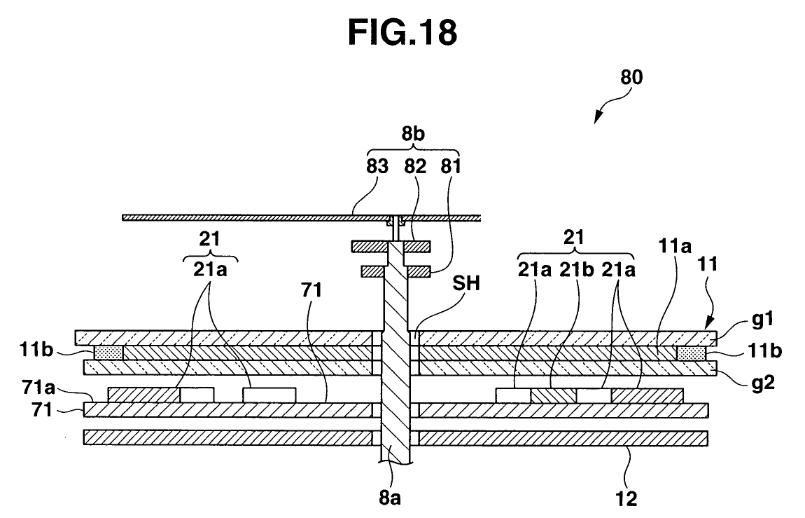

Now, an explanation will be given on an analog wristwatch 800 according to an eighth embodiment of the present invention with reference to FIG. 17 and FIG. 18.

Most components of the analog wristwatch 800 of the eighth embodiment are the same as those of the analog wristwatch 100 according to the first embodiment described above with reference to FIG. 1 to FIG. 4, and some components of the analog wristwatch of the seventh embodiment described with reference to FIG. 15 and FIG. 16. Therefore, in the description of the analog wristwatch 800 according to the eighth embodiment, the same reference numerals are given to the same components as those of the wristwatch 100 of the first embodiment and the wristwatch 700 of the seventh embodiment, and a detailed explanation will be omitted.

Only an ornament device 80 of the analog wristwatch 800 of the eighth embodiment is different from the analog wristwatch 100 of the first embodiment.

The ornament device 80 has an ornament plate 71 similar to the ornament plate 71 of the analog wristwatch 700 of the seventh embodiment described above with reference to FIG. 15 and FIG. 16, between the dye sensitizing solar battery 11 and electroluminescence element 12. On the surface 71a of the ornament plate 71 opposite to the dye sensitizing solar battery 11, the ornament portion 21 formed independently is fixed just like the ornament portion 21 of the analog wristwatch 200 of the second embodiment described with reference to FIG. 5 and FIG. 6.

The ornament plate 71 has a through hole in which a plurality of hand shafts 8a is inserted. The outer periphery of the ornament plate 71 is fixed to the predetermined position of the inner circumference of the housing space of the watch case 2.

The color of the ornament plate 71 is different from the color of the dye of the dye sensitizing solar battery element 11a of the dye sensitizing solar battery 11. Therefore, the user recognizes the color of the dye of the dye sensitizing solar battery element 11a when viewing the upper plate glass g1 of the dye sensitizing solar battery 11 through the watch glass 3 while the electroluminescence element 12 is not emitting light. The user recognizes the composite color made by the color of the ornament plate 71 and the color of the dye of the dye sensitizing solar battery element 11a, when viewing the upper plate glass g1 of the dye sensitizing solar battery 11 through the watch glass 3 while the electroluminescence element 12 is emitting light.

Like the ornament portion 21 of the analog wristwatch 200 of the second embodiment described with reference to FIG. 5 and FIG. 6, the ornament portion 21 includes time marks 21a and letters 21b.

All the external light coming into the housing space of the watch case 2 through the watch glass 3 can reach the whole surface of the upper plate glass g1 of the dye sensitizing solar battery 11.

As the ornament plate 71 is light transmittable, a very small portion of the light emitted from the electroluminescence element 12 is interrupted by the ornament portion 21, but almost all can reach the whole surface of the upper plate glass g2 of the dye sensitizing solar battery 11.

Therefore, when the analog wristwatch 800 of the eighth embodiment is used under external light either by emitting or without emitting light from the electroluminescence element 12, the dye sensitizing solar battery 11 can efficiently generate much electric power.

By changing the color of the ornament plate 71, the composite color made by the color of the ornament plate 71 and the dye of the dye sensitizing solar battery element 11a can be varied, and the effect of ornament portion can be changed.

The position to fix the ornament portion 21 is not limited to the ornament plate 71. The ornament portion 21 can be fixed to the outer surface g11 of the upper plate glass g1 of the dye sensitizing solar battery 11, or the outer surface g21 of the lower plate glass g2 (the surface opposite to the ornament plate 71), or both of the outer surface g11 of the upper glass g1 and the outer surface g21 of the lower plate glass. It is also possible to fix to the surface of the electroluminescence element 12 opposite to the ornament plate 71.

Instead of the ornament portion 21 fixed to the ornament plate 71, it is possible to print the ornament portion 13 of the first embodiment described with reference to FIG. 1 to FIG. 4 on the ornament plate 71, one or both of the outer surface g11 of the upper plate glass g1 and the outer surface g21 of the lower plate glass g1 of the dye sensitizing solar battery 11. It is also possible to print on the surface of the electroluminescence element 12 opposite to the dye sensitizing solar battery 11. It is also possible to form by etching the ornament portion 31 of the third embodiment described with reference to FIG. 7 and FIG. 8 on the ornament plate 71, one or both of the outer surface g11 of the upper plate glass g1 and the outer surface g21 of the lower plate glass 2 of the dye sensitizing solar battery 11.

[Ninth Embodiment]

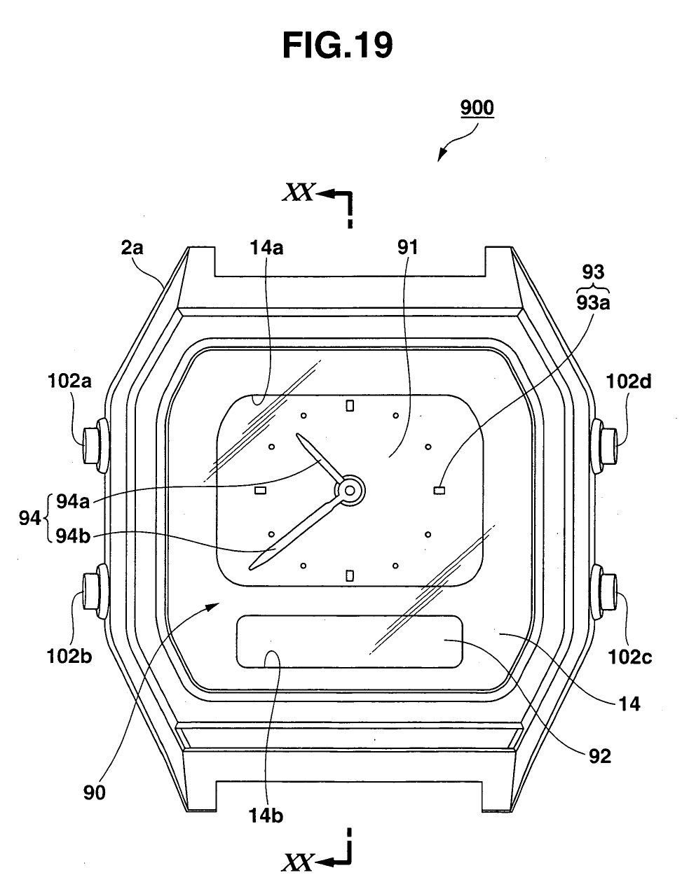

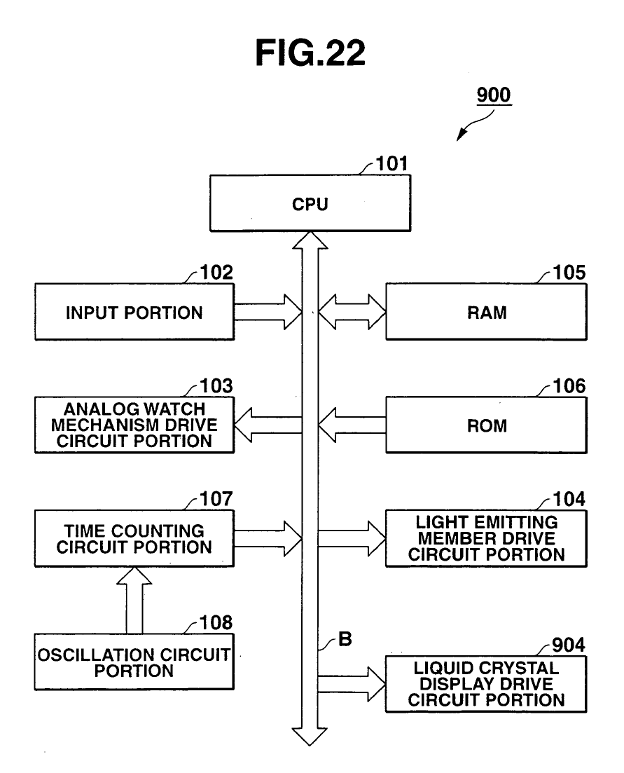

Now, an explanation will be given on an analog/digital wristwatch 900 according to a ninth embodiment of the present invention with reference to FIG. 19 and FIG. 22.

A portion of the components of the analog/digital wristwatch 900 of the ninth embodiment is the same as the analog wristwatch 100 according to the first embodiment described above with reference to FIG. 1 to FIG. 4. Therefore, in the description of the analog/digital wristwatch 900 according to the ninth embodiment, the same reference numerals are given to the same components as those of the wristwatch 100 of the first embodiment, and a detailed explanation will be omitted.

The watch case 2a as an apparatus case, watch glass 3a and upper housing 5a and lower housing 6a of the watch unit 1a have the same functions as the watch case 2, watch glass 3 and upper housing 5 and lower housing 6 of the watch unit 1 of the first embodiment. Thus, a detailed explanation on these components will also be omitted.

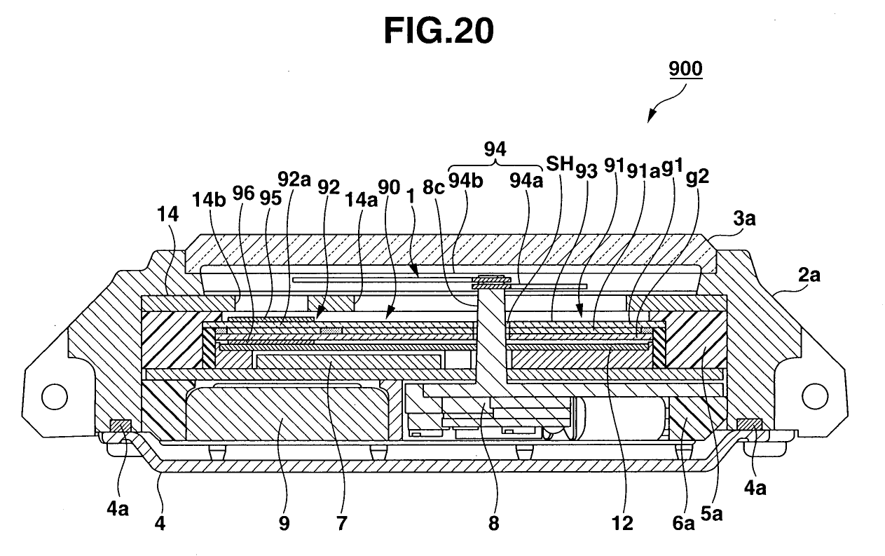

As shown in FIG. 19 and FIG. 20, in the housing space of the watch case 2a which houses the watch unit 1a, a partition frame 14 is placed between the watch glass 3a and the upper housing 5a of the watch unit 1a.

An ornament device 90 has a dye sensitizing solar battery 91 and liquid crystal display 92 which are adjacent to the partition frame 14 and placed on the same plane, and an electroluminescence element 12 as a light-projecting member which is placed adjoining to the opposite side of the partition frame 14 with respect to the dye sensitizing solar battery 91 and liquid crystal display 92. The dye sensitizing solar battery 91, liquid crystal display 92 and electroluminescence element 12 are held in the upper housing 5.

The partition frame 14 includes a solar battery window 14a and liquid crystal display window 14b corresponding to the dye sensitizing solar battery 91 and liquid crystal display 92.

The dye sensitizing solar battery 91 and liquid crystal display 92 include a pair of light transmittable plates including common upper plate glass g1 and lower plate glass g2. The dye sensitizing solar battery 91 has a dye sensitizing solar battery element 91a in a first area El corresponding to the solar battery window 14a of the partition frame 14 between the upper plate glass g1 and lower plate glass g2.

As shown in FIG. 19, an ornament portion 93 is printed at a predetermined position of the portion corresponding to the solar battery window 14a on the outer surface g11 of the upper glass g1 opposite to the watch glass 3a. More concretely, the ornament portion 93 have twelve time marks 93a printed at twelve positions placed at equal intervals along the above-mentioned portion of the outer surface g11 of the upper glass g1. Each of the twelve time marks 93a is circular or square.

The analog watch mechanism 8 includes a plurality of coaxial hand shafts 8c extending to between the ornament device 90 and watch glass 3 through a shaft hole SH formed in the ornament device 90, and a hand group 94 including an hour hand 94a and minute hand 94b fixed to the end of each of the hand shafts 8c.

The liquid crystal display 92 has a liquid crystal portion 92a in a second area E2 corresponding to the liquid crystal display window 14b of the partition frame 14 between the upper plate glass g1 and lower plate glass g2. Between the upper plate glass g1 and lower plate glass g2, each of the first area E1 in which the dye sensitizing solar battery element 91a is placed, and the second area E2 in which the liquid crystal portion 92a is placed, is sealed against the outside or mutually by a sealing member 11b.

In the portion corresponding to the second area E2 in the outer surface g11 of the upper plate glass g1, a light transmittable polarizing plate 95 as a portion of the liquid crystal display 92 is placed. In the portion corresponding to the second area E2 in the outer surface g21 of the lower plate glass g2, a semi-light transmittable polarizing plate with a reflection plate 96 as a portion of the liquid crystal display 92 is placed.

The liquid crystal portion 92a includes an upper light transmittable electrode (not shown) provided at the portion corresponding to the second area E2 on the inner surface of the upper plate glass g1, a lower light transmittable electrode (not shown) provided at the portion corresponding to the second area E2 on the inner surface of the lower plate glass g2, and a liquid crystal layer (not shown) sealed in the second area E2 between these not-shown upper and lower light transmittable electrodes. The liquid crystal layer is made of a twist mimetic (TN) crystal with a twist angle of 90°, for example.

The upper and lower light transmittable electrodes of the liquid crystal portion 92a are connected to the circuit board 7 by the not-shown wiring (omitted in the drawing).

The liquid crystal portion 92a is electrically connected to the liquid crystal display driving circuit portion 904 in the electric circuit on the circuit board 7 shown in FIG. 22. When the liquid crystal display driving circuit portion 904 applies a predetermined voltage to the upper and lower light transmittable electrodes of the liquid crystal portion 92a based on the output instruction signals generated from the CPU 101 according to the selective depression of the switches 102a, 102b, 102c and 102d of the input portion 102, the liquid crystal portion 92a digitally displays various information including time and date according to the applied voltage state.

Next, description will be give on the operation of the analog/digital wristwatch 900 configured as described above.

When sunlight or external light from an indoor lamp or outdoor lamp is projected to the upper plate glass g1 of the dye sensitizing solar battery 91 through the watch glass 3 and the solar battery opening 14a of the partition frame 14, the dye sensitizing solar battery 91a performs photoelectric conversion. The current obtained by the photoelectric conversion is once stored in the secondary battery 9.

The above-mentioned electric circuit of the analog/digital wristwatch 900 is driven by the current from the secondary battery 9.

When the analog watch mechanism driving circuit portion 103 of the analog watch mechanism 8 receives from the CPU 101 the time signal based on the current time data counted by the time counting circuit portion 107, the analog watch mechanism 8 displays the current time by pointing out any one of the time marks 93a of the ornament portion 93 of the ornament device 9 by the hour hand 94a and minute hand 94b.

At the same time, the liquid crystal display driving circuit portion 904 digitally displays various information including time and date in the liquid crystal portion 92a based on the output instruction signals generated from the CPU 101 according to the selective depression of the switches 102a, 102b, 102c and 102d of the input portion 102.

Under sunlight or external light from an indoor lamp and outdoor lamp, the user can visually recognize the current time displayed by pointing out any one of the time marks 93a of the ornament portion 93 of the ornament device 90 by the hour hand 94a and minute hand 94b through the watch glass 3a and the solar battery opening 14a of the partition frame 14. At the same time, the user can visually recognize the digital information displayed in the liquid crystal portion 92a through the watch glass 3a and the liquid crystal display opening 14b of the partition frame 14.

When the user presses one of the switches 102a, 102b, 102c and 102d related to ON/OFF of the electroluminescence element 12 in the input portion 102 at night, in cloudy weather or in a dark place, the CPU 101 outputs an output instruction signal to the light-emitting member driving circuit portion 104. Receiving the output instruction signal, the light-emitting member driving circuit portion 104 outputs a light emitting signal to the electroluminescence element 12. Receiving the light emitting signal, the electroluminescence element 12 emits light toward the dye sensitizing solar battery 91 and liquid crystal display 92 by the power stored in the secondary battery 9.

By the light from the electroluminescence element 12 passing through the dye sensitizing solar battery 91, the user can visually recognize the time marks 93a of the ornament portion 13 on the outer surface g11 of the upper plate glass g1 of the dye sensitizing solar battery 91, and the hour hand 94a and minute hand 94b of the analog watch mechanism 8. Namely, the user can know the current time by the recognized time marks 93a and the hour hand 94a and minute hand 94b of the analog watch mechanism 8.

While the light from the electroluminescence element 12 is passing through the dye sensitizing solar battery 91, a portion of the light is absorbed by the dye of the dye sensitizing solar battery element 91a and converted into electric current by the solar battery element 91a. The current generated by the photoelectric conversion is also stored in the secondary battery 9.

When the electroluminescence element 12 emits light, the user can also visually recognize the digital information displayed in the liquid crystal display 92 by the light transmitted through the liquid crystal display 92.

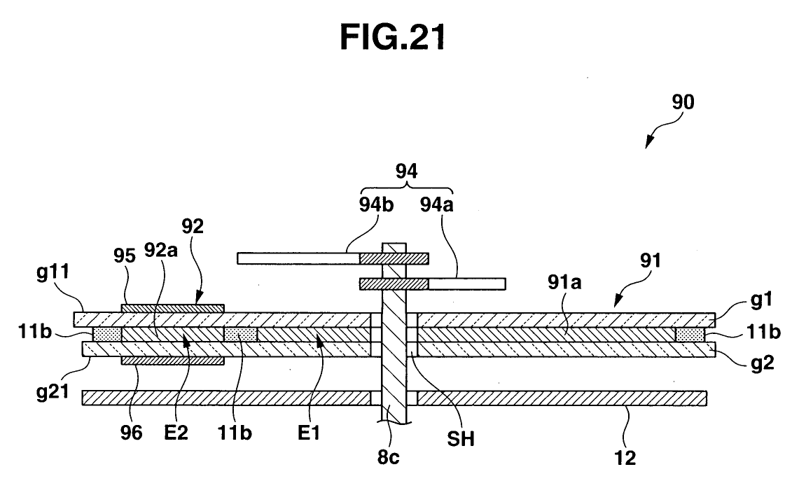

As explained above in detail with reference to FIG. 19 to FIG. 22, in the analog wristwatch 900 according to the ninth embodiment, the dye sensitizing solar battery 91 exposed to the whole surface of the solar battery opening 14a of the partition frame 14 in the housing space of the watch case 2a can generate sufficient electricity from the sunlight entered from the solar battery opening 14a or the external light from an indoor lamp or outdoor lamp, and can also generate electric power from a portion of the light emitted from the electroluminescence element 12 when light is emitted from the electroluminescence element 12 placed opposite to the sunlight incident side with respect to the dye sensitizing solar battery 91 in the housing space. Therefore, compared with the conventional case that a light-emitting member and a solar battery are placed on the same plane, the dye sensitizing solar battery 91 can generate increased electric energy.

Further, as the electroluminescence element 12 (light-emitting member) is placed opposite to the sunlight incident side with respect to the dye sensitizing solar battery 91, compared with the conventional case that a light-emitting member and a solar battery are placed on the same plane, the electroluminescence 12 (light-emitting member) can obtain a wider light-emitting area and emit increased amount of light.

When the electroluminescence element 12 emits light in a dark place, the dye sensitizing solar battery 91 generates electric power from a portion of the light emitted from the electroluminescence element 12, and the generated electric power is stored in the secondary battery 9. Namely, a portion of the power consumed by the electroluminescence element 12 is collected by the dye sensitizing solar battery 91, and the power consumption when the electroluminescence element 12 emits light can be decreased.

Further, the light emitted from the electroluminescence element 12 is transmitted through the whole surface of the dye sensitizing solar battery 91 of the ornament device 90 and the whole surface of the liquid crystal display 92. Therefore, when the electroluminescence element 12 emits light in a dark place, the light from the electroluminescence element 12 can light up all of the time marks 93a of the ornament portion 93 on the outer surface g11 of the upper plate glass g1, and the hour hand 94a and minute hand 94b, and the whole surface of the liquid crystal display 92. This improves the visibility of the ornament portion 93 and liquid crystal display 92 in a dark place.

As the ornament device 90 and liquid crystal display 92 share one electroluminescence element 12, compared with the case that two light-emitting members are used for each of the ornament device 90 and liquid crystal display 92, the mechanism for lighting the ornament device 90 and liquid crystal display 92 is simplified.

As the dye sensitizing solar battery 91 and liquid crystal display 92 are formed by using common upper plate glass g1 and lower plate glass g2, compared with the case that the dye sensitizing solar battery 91 and liquid crystal display 92 are independently formed and housed in the housing space of the watch case 2a, the manufacturing and assembling costs are decreased. At the same time, the space and volume necessary to house the dye sensitizing solar battery 91 and liquid crystal display 92 in the housing space can be decreased, and the outside dimensions of the analog/digital wristwatch 900 of the ninth embodiment can be decreased.

Further, as the time marks 93a of the ornament portion 93 are printed directly on the outer surface g11 of the upper plate glass g1, it is unnecessary to create separately an ornament plate having various ornaments including time marks and letters and to combine it with the dye sensitizing solar battery 91. This can make the ornament device 90 thin, and make the analog/digital wristwatch 900 thin.

The position to provide the ornaments 93 is not limited to the portion corresponding to the dye sensitizing solar battery 91 on the outer surface g11 of the upper plate glass g1. The ornaments 93 may be provided in the portion corresponding to the dye sensitizing solar battery 91 on the outer surface g21 of the lower plate glass g2 (the surface opposite to the electroluminescence element 12), or may be provided in the portion corresponding to the dye sensitizing solar battery 91 on both outer surface g11 of the upper plate glass g1 and the outer surface g21 of the lower plate glass g2.

Instead of the ornaments 93 printed on the outer surface g11 of the upper plate glass g1, it is possible to fix the ornament portion 21 of the second embodiment described with reference to FIG. 5 and FIG. 6 to the portion corresponding to the dye sensitizing solar battery 91 in one or both of the outer surface g11 of the upper plate glass g1 and the outer surface g21 of the lower plate glass g2. It is also possible to form by etching the ornament portion 31 of the third embodiment described with reference to FIG. 7 and FIG. 8 in the portion corresponding to the dye sensitizing solar battery 91 in one or both of the outer surface g11 of the upper plate glass g1 and the outer surface g21 of the lower plate glass g2.

The ornament portion 93 can include letters, digits, radial pattern, concentric circle pattern and grid pattern in addition to the figures of the time marks 13a. Further, the ornament portion 93 can also include the ornament plate 71, which is light transmittable as in the seventh and eighth embodiments shown in FIG. 15, FIG. 16 and FIG. 17, FIG. 18.

If a plurality of time marks, similar to the simple time marks provided on the surface of the frame member 15 opposite to the watch glass of the analog wristwatch 100 of the first embodiment shown in FIG. 1, is provided around the solar battery opening 14 on the surface of the partition frame 14 opposite to the watch glass 3, the user can know the current time also by the combination of the time marks with the hour hand 94a and minute hand 94b, as long as the user is in a light place.

Further, instead of using the electroluminescence element 12, it is possible to use the combination of the light guide plate 63 with the LED 62 used in the analog wristwatch 600 of the sixth embodiment described with reference to FIG. 13 and FIG. 14.

[Tenth Embodiment]

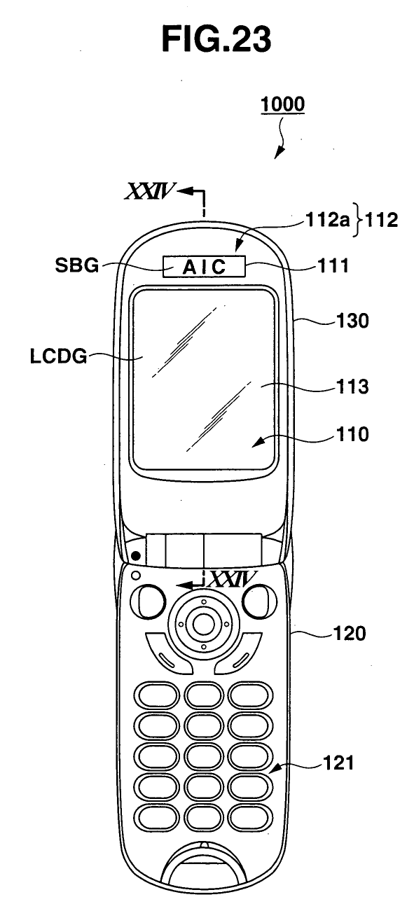

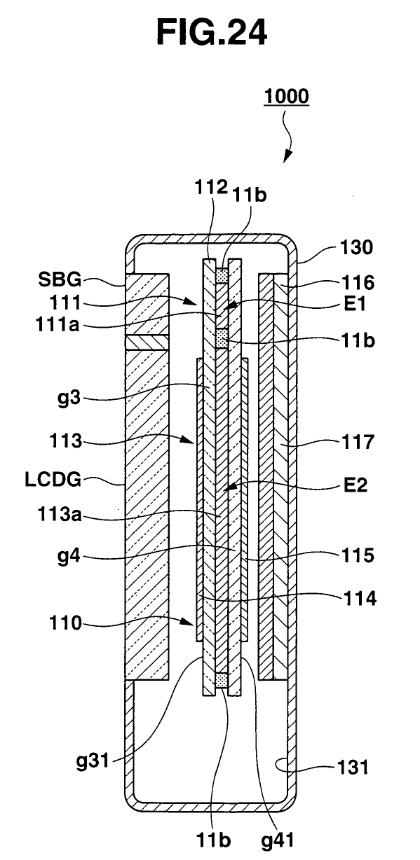

Now, an explanation will be given on a cellular phone 1000 according to a tenth embodiment of the present invention with reference to FIG. 23 and FIG. 24.

A portion of the components of the cellular phone 1000 of the tenth embodiment is the same as the analog wristwatch 100 of the first embodiment described with reference to FIG. 1 to FIG. 4 and the analog/digital wristwatch 900 of the ninth embodiment described above with reference to FIG. 19 to FIG. 22. Therefore, in the description of the cellular phone 1000 of the tenth embodiment, the same reference numerals are given to the same components as those of the analog wristwatch 100 of the first embodiment and the analog/digital wristwatch 900 of the ninth embodiment of the first embodiment, and a detailed explanation will be omitted.

As shown in FIG. 23, the cellular phone 1000 is of a folding type, for example, having a first case 120 having a key input portion 121, a second case 130 as an apparatus case connected to the first case 120 and movable rotationally between the closed position and developed position, and an ornament device 110 housed in the second case 130.

Various keys of the key input portion 121 are provided on the surface of the second case 120 hidden by the second case 130 at the closed position. A solar battery glass XBG to cover a solar battery window and a liquid crystal display glass LCDG to cover a liquid crystal display window are provided on the surface of the second case 130 covering the first case 120 at the closed position.

The liquid crystal display glass LCDG is provided close to the end of the second case 130 connected to the first case 120, and the solar battery glass SBG is provided close to the free end far from the connected end. The surface area of the liquid crystal display glass LCDG is much larger than the surface area of the solar battery glass SBG.

In the housing space of the second case 130, an upper plate glass g3 is placed opposite to the liquid crystal display glass LCDG and solar battery glass SBG, and a lower plate glass g4 is placed parallel to the upper glass g3 on the opposite side of the liquid crystal display glass LCDG and solar battery glass SBG with respect to the upper plate glass g3.

In a first area E1 corresponding to the solar battery glass SBG between the upper plate glass g3 and lower plate glass g4, a dye sensitizing solar battery element 111a similar to the dye sensitizing solar battery element 91a of the dye sensitizing solar battery 91 of the analog/digital wristwatch 900 of the ninth embodiment described with reference to FIG. 19 to FIG. 22 is placed. On the inner surface corresponding to the dye sensitizing solar battery element 111a in the upper plate glass g3 and lower plate glass g4, a not-shown light transmittable electrode of the dye sensitizing solar battery 91 is placed. The not-shown light transmittable electrode is connected to a not-shown secondary battery in the first case 120 by a not-shown wiring.

The ornament device 110 includes ornament portion 112 printed in the portion opposite to the solar battery glass SBG on the outer surface g31 of the upper plate glass g3 opposite to the liquid crystal display glass LCDG and solar battery glass SBG. The ornament portion 112 has English letters “AIC”.

A light transmittable polarizing plate 114 is provided at the position corresponding to a liquid crystal portion 113a on the outer surface g31 of the upper plate glass g3. A semi-light transmittable polarizing plate with a reflection plate 115 is provided at the position corresponding to the liquid crystal portion 113a on the outer surface g41 of the lower plate glass g4.

An electroluminescence element 116 is fixed through a board 117 to an inside wall 131 at the rear side (opposite to the sunlight incident side) of the second case 130.

In this cellular phone 1000, when a certain key of the key input portion 121 is pressed, or when the second case 130 is moved rotationally from the folded state, a display driving circuit portion 904 (refer to FIG. 22) outputs a light emitting signal to the electroluminescence element 12, and the electroluminescence element 12 emits light to the dye sensitizing solar battery element 111a and liquid crystal portion 113a, thereby the ornament portion 112 and the display in the liquid crystal display 113 can be recognized.

As described above, since the cellular phone 1000 of the tenth embodiment has a light transmittable dye sensitizing solar battery 111 which has a pair of light transmittable plates (upper plate glass g3 and lower plate glass g4) and a dye sensitizing solar battery element 111a placed in the area between these light transmittable plates, an electroluminescence element 116 which is placed opposite to the sunlight incident side of the dye sensitizing solar battery 111 and projects light to the dye sensitizing solar battery 111, and an ornament portion 112 which is provided on the outer surface g11 of the upper plate glass g1, the dye sensitizing solar battery 111 can generate electric power from external light and the light projected from the electroluminescence element 116. This increases the electric power generated by the dye sensitizing solar battery 111.

As the electroluminescence element 116 (light-projecting member) is placed on the opposite side of the sunlight incident side of the dye sensitizing solar battery 111, compared with the conventional case that the light-projecting member and solar battery are placed on the same plane, the electroluminescence element 116 with a wide light-emitting area can be used, and the light-emitting volume can be increased.

Further, as letters 112a are printed on the outer surface g31 of the upper plate glass g3, the upper plate glass g3 serves as an ornament portion, and it is unnecessary to provide a separate ornament member. Thus, the ornament device 110 can be made thin.

The light emitted from the electroluminescence element 116 passes through the ornament device 110 (the dye sensitizing solar battery element 11a and liquid crystal portion 113a), and reaches the sunlight incident side of the wristwatch 9000. Therefore, By emitting light from the electroluminescence element 116 in a dark plate, the ornament portion 112 and liquid crystal display 113 can be lit up by that light, and the time and ornaments indicated by the wristwatch 900 can be recognized.

In the configuration forming an ordinary liquid crystal display 113 which holds the liquid crystal portion 113a between the upper plate glass g3 and lower plate glass g4, the dye sensitizing solar battery 111 can be provided between the upper plate glass g3 and lower plate glass g4. This eliminates the necessity of providing the dye sensitizing solar battery 111 and liquid crystal display 113 in the thickness direction. Thus, ornament device 110 can be made thin. As a result, the cellular phone 1000 can be made thin.

In the configuration of the ornament portion 112 of the ornament device 110 of the cellular phone 1000 described above, only the letters 112a are printed on the upper plate glass g3. But, it is permitted to print figures such as logotypes. It is also permitted to form the ornament portion by typesetting, sticking or etching, as described in Embodiments 2 and 3.

The position to form the ornament portion 112 is not limited to the outer surface g31 of the upper plate glass g3. It is permitted to form on the outer surface g41 of the lower plate glass g4 (the side of the electroluminescence element 12), for example.

Instead of providing the electroluminescence element 116, it is permitted to provide the LED 62 and light guide plate 63 as described in Embodiment 6.

It is also permitted to provide a member corresponding to the light transmittable ornament plate 71 as described in Embodiment 7.

As described above, according to Embodiments 1 to 10, by forming an ornament device by using a dye sensitizing solar battery, a wide light-receiving area can be ensured as compared with an apparatus using a conventional solar battery. This can make the apparatus compact.

Further, as a dye sensitizing solar battery can be powered by external light and light projected from a light-projecting member, much value of power can be generated as compared with a conventional ornament device.

Comparing with the same size unit using a conventional solar battery, the light-emitting area of an electroluminescence layer can be enlarged, and much more light-emitting volume can be ensured, and the visibility can be increased even in a dark place.

If an ornament device is configured to be able to store the electric power generated by a solar battery by providing a secondary battery or the like in an ornament device, for example, the light-projecting member can emit light by using the power generated from the light emitted from the light-projecting member, and the power consumed by emitting light from the light-projecting member can be decreased. This increases the power efficiency of an ornament device.

Further, as a light transmittable plate can serve as a conventional ornament member, it is unnecessary to provide a separate ornament member. This can make the ornament device thin.

Further, when a colored ornament plate, which is light transmittable, is provided as an ornament plate, the composite color made by the color of this ornament plate and the color of the dye sensitizing solar battery element is recognized, and the color variations of ornament portion can be increased.

Further, by providing a dye sensitizing solar battery element and liquid crystal portion in different areas between a pair of light transmittable plates, one light-projecting member can project light to both of the area provided with the dye sensitizing solar battery element and the area provided with the liquid crystal portion.

In the above-mentioned Embodiments 1 to 10, a wristwatch and cellular phone are explained as examples of an electronic apparatus. But, the present invention is not limited to these apparatus. The invention is applicable to other various electronic apparatus, such as PDA, personal computer and automobile instruments.

The time marks of the ornament portion may be Arabic numerals, Roman numerals, or figures such as circle and ellipse.

The letters of the ornament portion may consist of logotypes of company names and product names or the like.

The number and locations of these time marks and letters are also not limited.

The ornament portion may be formed by combining the above-mentioned printing, planting, sticking and etching.

As a dye in the dye sensitizing solar battery 11, ruthenium is taken as an example, but other dyes such as merocyanin coumarin and phenanthroline groups can be used.

Of course, the other concrete detail structures can also be modified appropriately.

[Eleventh Embodiment]

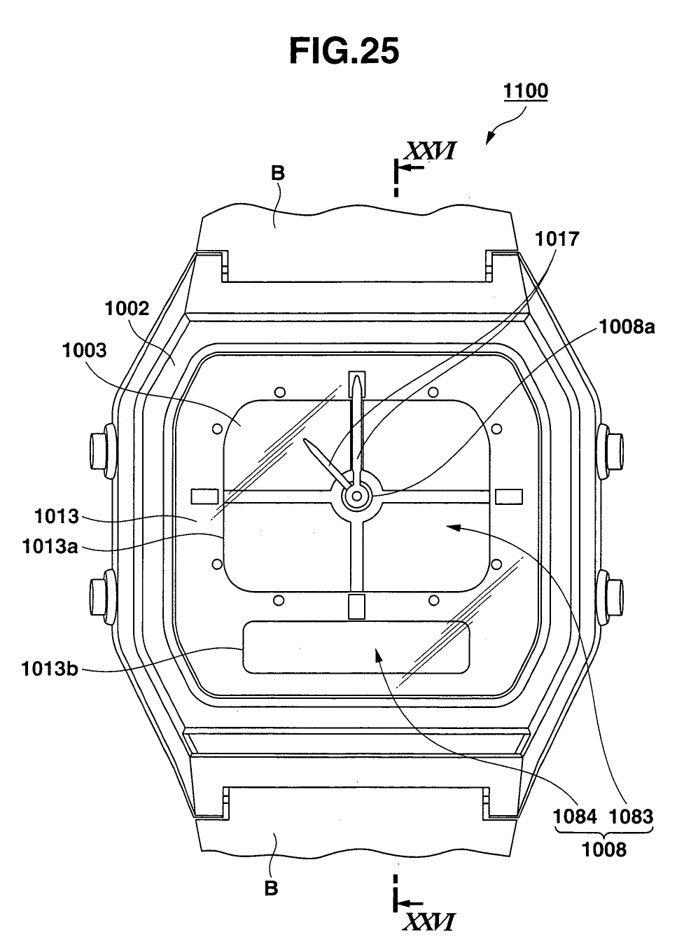

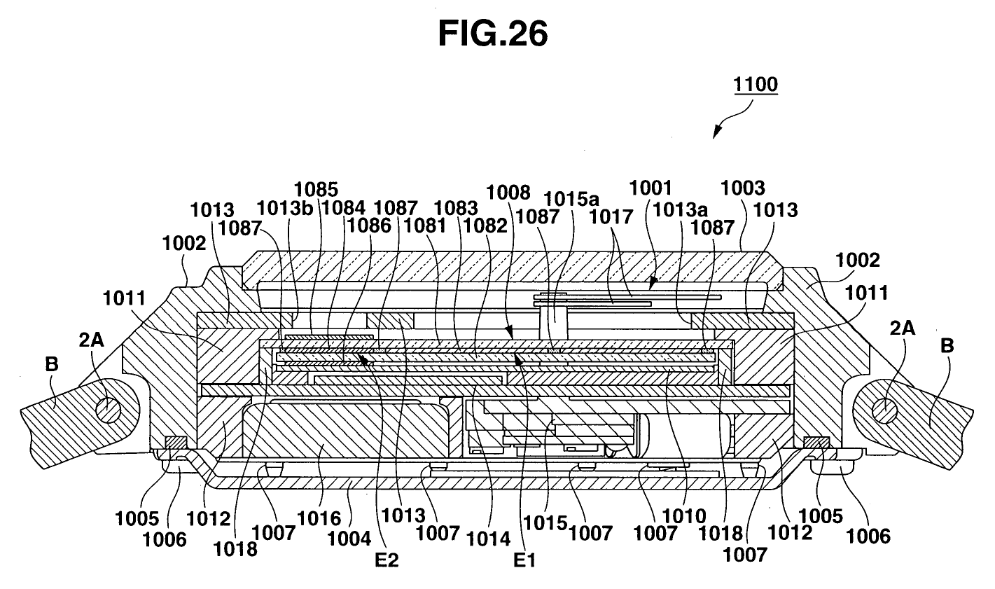

FIG. 25 is a plane view of a wristwatch according to an eleventh embodiment of the present invention. FIG. 26 is a sectional view taken along lines XXVI-XXVI of FIG. 25.

As shown in FIG. 25 and FIG. 26, a wristwatch 1100 has a watch case 1002 as an apparatus case to house a time counting portion 1001, and a watch glass 1003 is fit at the center of the upper portion of the watch case 1002. In the lower surface of the watch case 1002, a rear cover 1004 is fixed with a screw 1006 through a waterproof ring 1005. A buffer member 1007 is provided between the time counting portion 1001 and rear cover 1004. A watch band B is fixed to the watch case 1002 through a band shaft 2A.

The time counting portion 1001 has at least a digital function. The one shown in FIG. 25 and FIG. 26 has both digital and analog functions.

As shown in FIG. 26, in the time counting portion 1001, an upper housing 1011 and lower housing 1012 are provided. On the upper surface of the upper housing 1011, a watch-face having time marks is placed. A circuit board 1014, such as PWB, is placed between the upper housing 1011 and lower housing 1012.

In the upper housing 1011, a display device 1008 according to the present invention is provided. The display device 1008 is housed in the upper housing 1011 of the time counting portion 1001, and placed in the watch case 1002. On the opposite side of the visible side of the display device 1008 in the upper housing 1011, an electroluminescence element 1010 as a light-projecting portion is placed as a backlight. The electroluminescence element 1010 is a light-emitting element capable of outputting a predetermined light.

In the lower housing 1012, an analog hand mechanism 1015 and a secondary battery 1016 to store the power generated by a dye sensitizing solar battery 1083 as a solar battery portion are incorporated.

The analog hand mechanism 1015 has a hand shaft 1015a extending upward from a shaft hole 1008a provided in the display device 1008, and hands 1017, such as hour hand and minute hand fixed to the hand shaft 1015a. The analog hand mechanism is constructed to cause the hands 1017 to move on the surface of the watch-face 1013.

The display device 1008, electroluminescence element 1010 and analog hand mechanism 1015 are electrically connected to the circuit board 1014. The secondary battery 1016 is also electrically connected to the circuit board 1014.

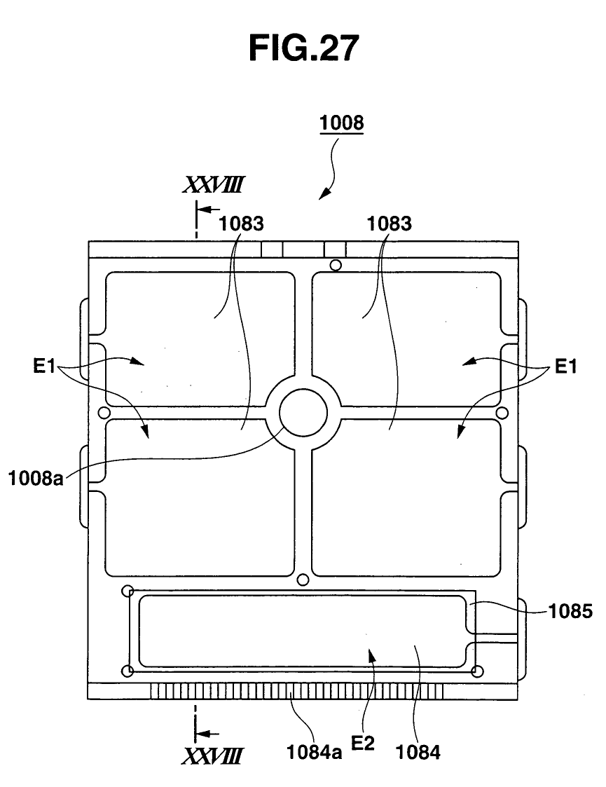

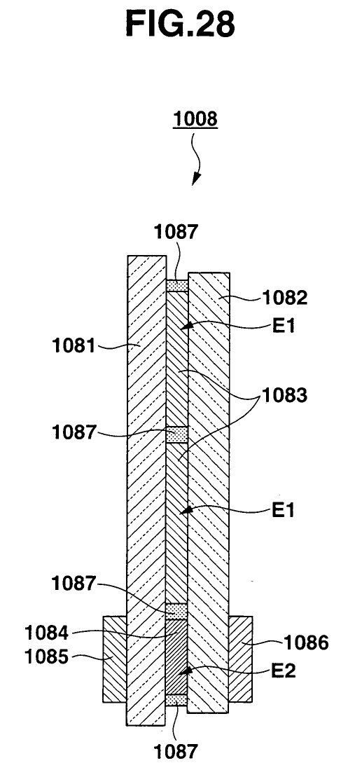

As shown in FIG. 26, FIG. 27 and FIG. 28, the display device 1008 has an upper plate glass 1081 as a first light transmittable plate, a lower plate glass 1082 as a second light transmittable plate, a dye sensitizing solar battery portion 1083 as a solar battery portion provided in a first area E1 between the upper plate glass 1081 and lower plate glass 1082, a liquid crystal portion 1084 provided in a second area E2 between the upper plate glass 1081 and lower plate glass 1082, a light transmittable polarizing plate 1085 as a first polarizing plate provided corresponding to the liquid crystal portion 1084 on the upper surface or the visible side of the upper plate glass 1081, a semi-light transmittable polarizing plate with a reflection plate 1086 as a second polarizing plate provided corresponding to the liquid crystal portion 1084 on the lower surface or the side opposite to the visible side of the lower plate glass 1082.

The first area E1 and second area E2 are partitioned by a sealing member 1087. The dye sensitizing solar battery portion 1083 and liquid crystal portion 1084 are isolated. The sealing member 1087 is preferably made of resin or the like, which is light transmittable.

In the display device 1008, the dye sensitizing solar battery portion 1083 is placed around the shaft hole 1008a in being divided into four blocks (concretely, a block between 12 o'clock and 3 o'clock corresponding to the time marks on the watch-face 1013, a block between 3 o'clock and 6 o'clock, a block between 6 o'clock and 9 o'clock, and a block between 9 o'clock and 12 o'clock). The liquid crystal portion 1084 is placed under the dye sensitizing solar battery portion 1083 (lower side in the direction of viewing the wristwatch 1100) in the display device 1008.

The electroluminescence element 1010 can project light to the display device 1008 from the opposite side of the visible side, and can project light to both of the dye sensitizing solar battery portion 1083 and liquid crystal portion 1084 of the display device 1008.

The dye sensitizing solar battery portion 1083 has a not-shown upper light transmittable electrode provided in the lower surface of the upper plate glass 1081, a not-shown lower light transmittable electrode provided on the upper surface of the lower plate glass 1082, a not-shown metal oxide layer absorbing a predetermined dye and a not-shown electric charge transfer layer having a predetermined electrolyte which are sealed between the upper light transmittable electrode and lower light transmittable electrode. The dye sensitizing solar battery portion 1083 is visible through the battery window 1013a formed on the watch-face 1013, and receives external light such as sunlight entered through the battery window 1013a.

The dye sensitizing battery portion 1083 is light transmittable, and can transmit the light emitted by the electroluminescence element 1010 as backlight to the visible side of the wristwatch 1100.

As a dye, for example, a ruthenium complex (RuL₂(NCS)₂, L=4.4′-dicarboxy-2.2′ bipyridine) can be used. A metal oxide layer is formed by adhering to a titanium oxide (TiO₂) as a metal oxide. As an electrolyte, an iodide can be used. An electric charge transfer layer can be formed by adding the lithium iodine or metal iodine to polyethylene glycol, for example.

When light is projected to the dye sensitizing solar battery portion 1083, the dye absorbed in the metal oxide layer (omitted in the drawing) of the dye sensitizing solar battery portion 1083 absorbs the light energy and emits an electron. The emitted electron is transferred to one light transmittable electrode through the titanium oxide, and sent from that light transmittable electrode to a given load resistor (e.g., the analog hand mechanism 1015 of the time counting portion 1001 or the liquid crystal portion 1084). The electron moved through that load resistor reaches the other light transmittable electrode, and returns to the dye through the electrolyte layer (omitted in the drawing). A current is generated by this circulation of electron, and electric energy can be supplied to the load resistor.

The liquid crystal portion 1084 has a not-shown upper light transmittable electrode provided on the lower surface of the upper plate glass 1081, a not-shown lower light transmittable electrode provided on the upper surface of the lower plate glass 1082, and a not-shown liquid crystal layer sealed between the upper light transmittable electrode and lower light transmittable electrode. The liquid crystal layer (omitted in the drawing) uses a twist mimetic (TN) crystal with a twist angle of 90°, for example.

In the display device 1008, the liquid crystal display consists of a liquid crystal portion 1084 held by the upper plate glass 1081 and lower plate glass 1082, a light transmittable polarizing plate 1085 provided corresponding to the liquid crystal portion 1084, and a semi-light transmittable polarizing plate with a reflection plate 1086. Information such as time and date are digitally displayed according to the state of applying a voltage to the not-shown pair of light transmittable electrodes in the liquid crystal portion 1084.

As shown in FIG. 27, wiring 1084a extending from the not-shown light transmittable electrodes (upper and lower light transmittable electrodes) is provided from the liquid crystal portion 1084 (light transmittable electrodes) toward the lower side of the dye sensitizing solar battery portion 1083 (the lower side in the direction of viewing the wristwatch 1100). The wiring 1084a is connected to a connector 1018 connected to the circuit board 1014.

The liquid crystal portion 1084 (liquid crystal display) is placed to receive external light such as sunlight entered through a liquid crystal window 1013b formed in the watch-face 1013, and the liquid crystal display (digital display) of the liquid crystal portion 1084 (liquid crystal display) can be recognized through the liquid crystal window 1013b.

By using the light transmittable polarizing plate 1085 as a first polarizing plate and the semi-light transmittable polarizing plate with a reflection plate 1086 as a second polarizing plate, the light emitted from the electroluminescence element 1010 can be transmitted to the visible side through the semi-light transmittable polarizing plate with a reflection plate 1086, and can be projected to the liquid crystal portion 1084 (liquid crystal display). Namely, in a dark place, the liquid crystal portion 1084 (liquid crystal display) can be lit up and recognized by the light emitted from the electroluminescence element 1010 as a backlight.

As described above, the display device 1008 is constructed to hold the dye sensitizing solar battery portion 1083 and liquid crystal portion 1084 between the upper plate glass 1081 and lower plate glass 1082, and has the light transmittable polarizing plate 1085 and semi-light transmittable polarizing plate with a reflection plate 1086 at the positions corresponding to the liquid crystal portion 1084, whereby the display device 1008 itself is light transmittable.

That is, as the light emitted from the electroluminescence element 1010 as a backlight reaches the visible side of the wristwatch 1100 passing through the display device 1008 (the dye sensitizing solar battery portion 1083 and liquid crystal portion 1084), the watch-face 1013, hands 1017 on the watch-face 1013 and liquid crystal portion 1084 (liquid crystal display) can be lit up by the light emitted from the electroluminescence element 1010, and the time indicated by the wristwatch 1100 can be recognized in a dark place.

The dye sensitizing solar battery portion 1083 can also generate electric power by the light outputted from the electroluminescence element 1010 from the rear side (lower side) of the dye sensitizing solar battery portion 1083, as well as by sunlight or light from an indoor lamp entered from the visible side. Therefore, the dye sensitizing solar battery portion 1083 of the display device 1008 can efficiently generate electric power.

The generated electric power can be stored in the secondary battery 1016, and the power stored in the secondary battery 1016 can be used as a power supply to the wristwatch 1100.

In the structure of a common liquid crystal display that the liquid crystal portion 1084 is held between the upper plate glass 1081 and lower plate glass 1082, the display device 1008 can also include the dye sensitizing solar battery portion 1083 as a solar battery portion between the upper plate glass 1081 and lower plate glass 1082. Thus, it is unnecessary to provide the liquid crystal portion 1084 and dye sensitizing solar battery portion 1083 in the thickness direction, and the display device 1008 having the liquid display and solar battery portion can be made thin.

As the wristwatch 1100 has the above display device 1008 in the time counting portion 1001, the liquid crystal portion 1084 of the display device 1008 provides the liquid crystal display function (digital display function), and the dye sensitizing solar battery portion 1083 of the display device 1008 generates electric power. The generated power is stored in the secondary battery 1016, and the secondary battery is always charged. This eliminates the necessity of replacing the battery.

The display device 1008 can be made thinner than a display device having a conventional solar battery portion. Thus, the wristwatch 1100 using the display device 1008 can be made thin.

As the light emitted from the electroluminescence element 1010 passes through the display device 1008 (the dye sensitizing solar battery portion 1083 and liquid crystal portion 1084), and lights up the watch-face 1013, hands 1017 on the watch-face 1013 and liquid crystal portion 1084 (liquid crystal display), the time indicated by the wristwatch 1100 can be recognized even in a dark place.

As the dye sensitizing solar battery portion 1083 of the display device 1008 has the color based on the dye contained in a not-shown metal oxide layer, the light emitted from the electroluminescence element 1010 and transmitted through the dye sensitizing solar battery portion 1083 becomes a colored light having the colors corresponding to the various dyes contained in the metal oxide layer. Therefore, the wristwatch 1100 can be a luxurious wristwatch colored by such dyes.

[Twelfth Embodiment]

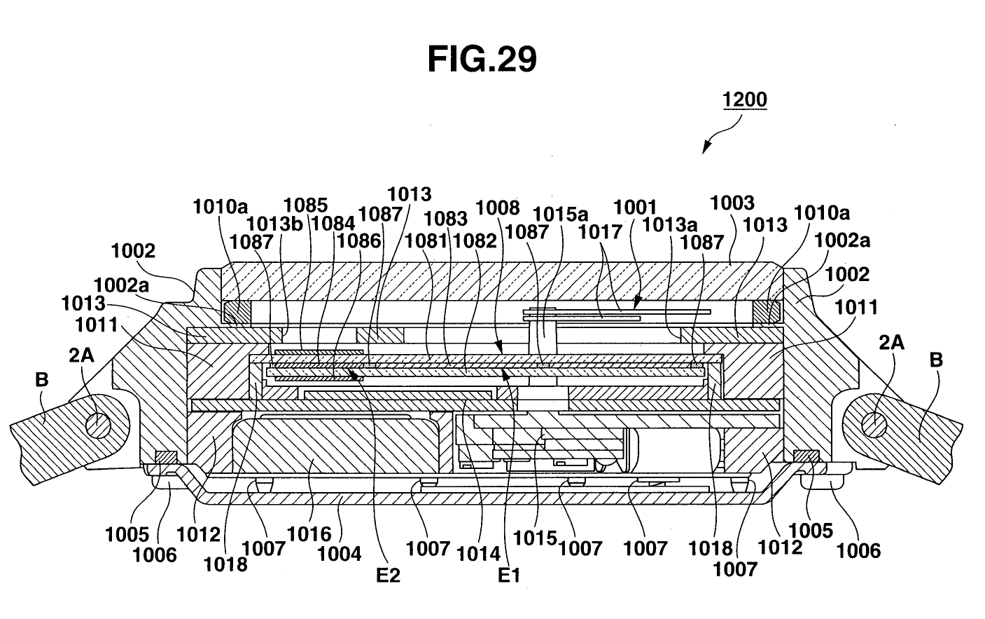

Next, description will be given on a twelfth embodiment in which the present invention is applied to a wristwatch with reference to FIG. 29. Same reference numerals are given to the same components as those of the eleventh embodiment, and only the different components will be explained.

As shown in FIG. 29, in a wristwatch 1200, a light-emitting element 1010a as a light-projecting portion is provided between the upper surface of a projection 1002a of a watch case 1002 and the lower surface of a watch glass 1003, in the upper side of the watch-face 1013. The light-emitting element 1010a is electrically connected to the circuit board 1014 by not-shown wiring.

The light-emitting element 1010a is a light-emitting element as a front light capable of outputting a predetermined light.

The light-emitting element 1010a can project light from the visible side of the display device 1008, and can project light to both of the dye sensitizing solar battery portion 1083 and liquid crystal portion 1084 of the display device 1008. The light-emitting element 1010a projects light also to the watch-face 1013 and the hands 1017 on the watch-face.

In such a wristwatch 1200, the light emitted from the light-emitting element 1010a lights up the watch-face 1013, hands 1017 on the watch-face 1013, and liquid crystal portion 1084 (liquid crystal display). Thus, the time indicated by the wristwatch 1200 can be recognized even in a dark place.

The dye sensitizing solar battery portion 1083 of the display device 1008 can generate electric power from sunlight, the light from an indoor lamp, and the light emitted from the light-emitting element 1010a. The generated electric power can be stored in the secondary battery 1016.

Of course, the twelfth embodiment can provide the other effects similar to those of the eleventh embodiment.

[Thirteenth Embodiment]

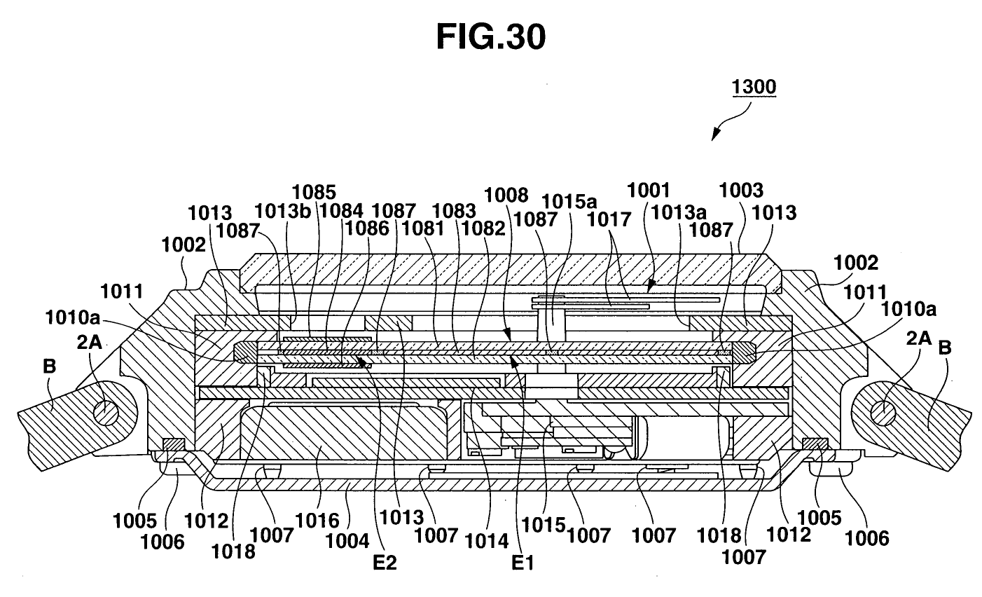

Next, description will be given on a thirteenth embodiment in which the present invention is applied to a wristwatch with reference to FIG. 30. Same reference numerals are given to the same components as those of the eleventh embodiment, and only the different components will be explained.

As shown in FIG. 30, in a wristwatch 1300, a light-emitting element 1010a as a light-projecting portion is provided at the peripheral side portion of a display device 1008 just like being buried in an upper housing 1011. The light-emitting element 1010a is electrically connected to a circuit board 1014 by not-shown wiring.

The light-emitting element 1010a is a light-emitting element as a side light capable of outputting a predetermined light.

The light-emitting element 1010a can project light from the side of the display device 1008, and can project light to both of the dye sensitizing solar battery portion 1083 and liquid crystal portion 1084 of the display device 1008. Particularly, the light outputted from the light-emitting element 1010a is guided by the upper plate glass 1081 and lower plate glass 1082, both of which are light transmittable, and emitted from the upper surface and lower surface of the upper plate glass 1081 and lower plate glass 1082. Thus, the emitted light can be preferably projected to the dye sensitizing solar battery portion 1083, liquid crystal portion 1084, watch-face 1013, and hands 1017 on the watch-face 1013.

In such a wristwatch 1300, the light emitted from the light-emitting element 1010a lights up the watch-face 1013, hands 1017 on the watch-face 1013, and liquid crystal portion 1084 (liquid crystal display). Thus, the time indicated by the wristwatch 1300 can be recognized even in a dark place.

The dye sensitizing solar battery portion 1083 of the display device 1008 can generate electric power from sunlight, the light from an indoor lamp, and the light emitted from the light-emitting element 1010a. The generated electric power can be stored in the secondary battery 1016.

Of course, the thirteenth embodiment can provide the other effects similar to those of the eleventh embodiment.

[Fourteenth Embodiment]

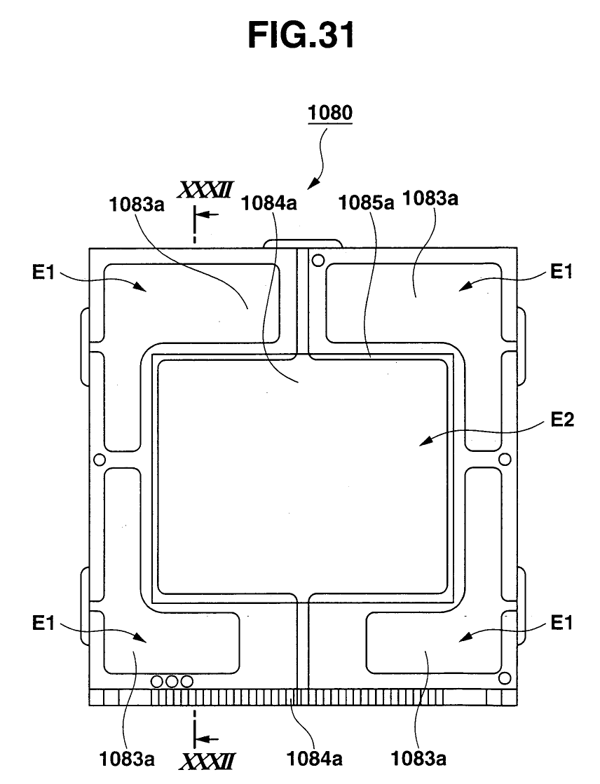

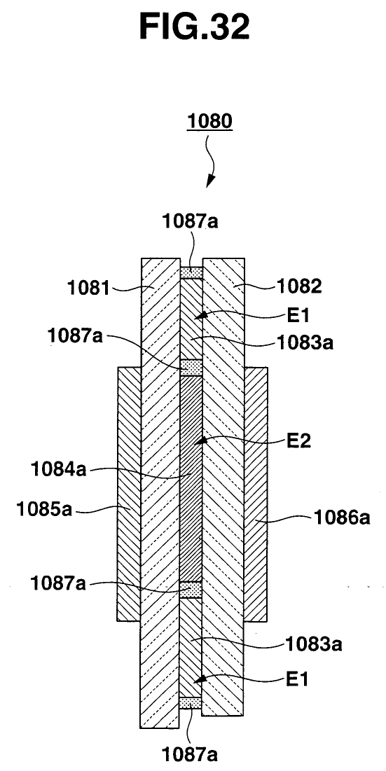

Next, description will be given on a fourteenth embodiment in which the present invention is applied to a wristwatch with reference to FIG. 31 and FIG. 32. Same reference numerals are given to the same components as those of the eleventh embodiment, and only the different components will be explained.

A display device provided in a time counting portion of a wristwatch according to the present invention can be a display device 1080 having the structure shown in FIG. 31 and FIG. 32.

The display device 1080 has an upper plate glass 1081 as a first light transmittable plate, a lower plate glass 1082 as a second light transmittable plate, a dye sensitizing solar battery portion 1083a as a solar battery portion provided in a first area E1 between the upper plate glass 1081 and lower plate glass 1082, a liquid crystal portion 1084a provided in a second area E2 between the upper plate glass 1081 and lower plate glass 1082, a light transmittable polarizing plate 1085a as a first polarizing plate placed corresponding to the liquid crystal portion 1084a on the upper surface or the visible side of the upper plate glass 1081, and a semi-light transmittable polarizing plate with a reflection plate 1086a as a second polarizing plate placed corresponding to the liquid crystal portion 1084a on the lower surface or the side opposite to the visible side of the lower plate glass 1082.

The first area E1 and second area E2 are partitioned by a sealing member 1087a. The dye sensitizing solar battery portion 1083a and liquid crystal portion 1084a are isolated. The sealing member 1087a is preferably made of resin or the like, which is light transmittable.

The liquid crystal portion 1084a is placed at almost the center (almost the center in the direction of viewing the wristwatch) in the display device 1080.

The dye sensitizing solar battery portion 1083a is placed in being divided into four blocks at the periphery of the liquid crystal portion 1084a in the display device 1080, and at the four corners of the display device 1080.

The display device 1080 configured as described above is constructed to be light transmittable in the display device 1080 itself.

Therefore, the display device 1080 can be lit up of course by the front light provided in the visible side of the display device 1080, and also by the light from the backlight provided opposite to the visible side of the display device 1080, and the side light provided at the periphery side portion of the display device 1080, that is, by the light outputted from these lights (light-emitting element and light-projecting portion). Both of the dye sensitizing solar battery portion 1083a and liquid crystal portion 1084 of the display device 1080 can be lit up by these lights.

By providing such a display device 1080 in a wristwatch, the wristwatch is given a liquid crystal display function (digital display function) by the liquid crystal portion 1084a of the display device 1080. The electric power generated by the dye sensitizing solar battery portion 1083a of the display device 1080 is charged in the secondary battery 1016. The secondary battery 1016 supplies power to the wristwatch.

Of course, the fourteenth embodiment can provide the other effects similar to those of the eleventh embodiment.

[Fifteenth Embodiment]

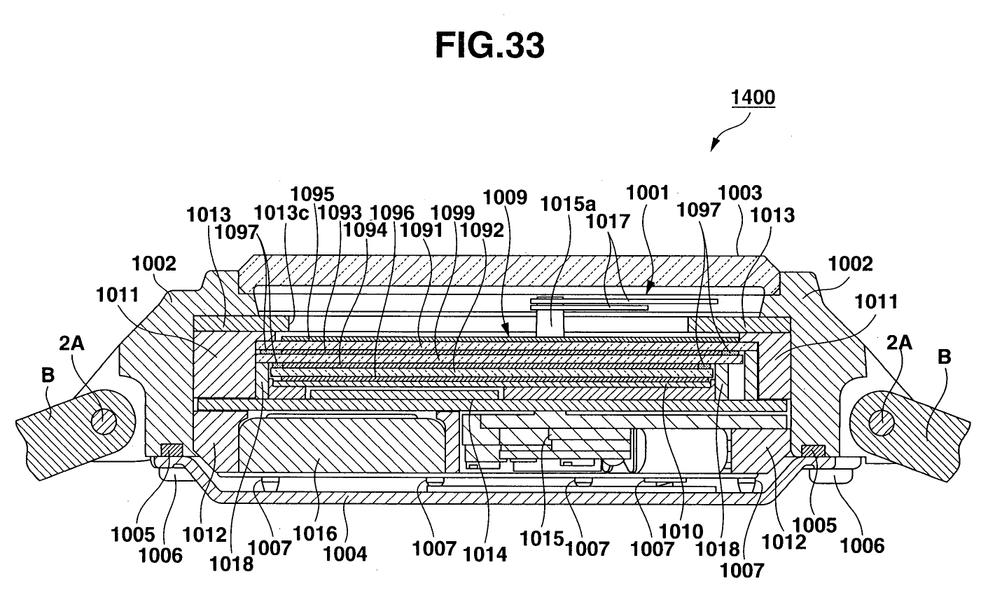

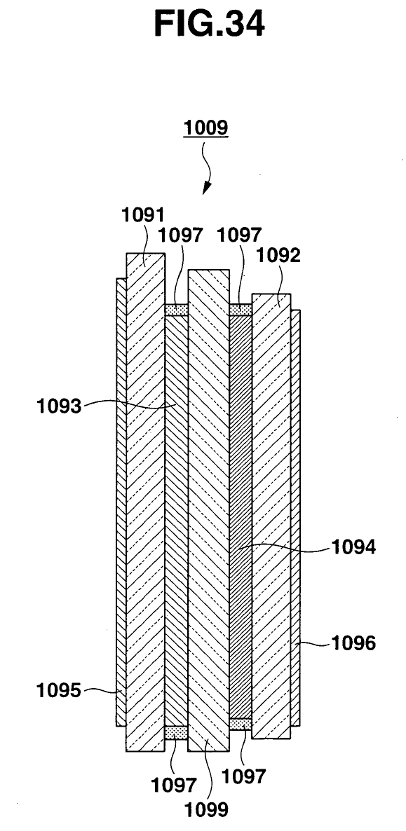

Next, description will be given on a fifteenth embodiment in which the present invention is applied to a wristwatch with reference to FIG. 33 and FIG. 34. Same reference numerals are given to the same components as those of the eleventh embodiment, and only the different components will be explained.

As shown in FIG. 33 and FIG. 34, a display device 1009 according to the present invention is provided in an upper housing 1011 of a time counting portion 1001 of a wristwatch 1400. The display device 1009 is housed in the time counting portion 1001 (the upper housing 1011), and placed in the watch case 1002. On the opposite side of the visible side of the display device 1009 in the upper housing 1011, an electroluminescence element 1010 as a light-projecting portion is placed as a backlight.

The electroluminescence 1010 can project light to the display device 1009 from the opposite side of the visible side, and project light to of the both dye sensitizing solar battery portion 1093 and liquid crystal portion 1094 of the display device 1009.

As shown in FIG. 33 and FIG. 34, the display device 1009 has an upper plate glass 1091 as a first light transmittable plate, a lower plate glass 1092 as a second light transmittable plate placed opposite to the visible side of the upper plate glass 1091, an intermediate plate glass 1099 as an intermediate light transmittable plate placed between the upper plate glass 1091 and lower plate glass 1092, a dye sensitizing solar battery portion 1093 as a solar battery portion placed between the upper plate glass 1091 and intermediate plate glass 1099, a liquid crystal portion 1094 placed between the intermediate plate glass 1099 and lower plate glass 1092, a light transmittable polarizing plate 1095 as a first polarizing plate placed corresponding to the liquid crystal portion 1094 on the upper surface or the visible side of the upper plate glass 1091, and a semi-light transmittable polarizing plate with a reflection plate 1096 as a second polarizing plate placed corresponding to the liquid crystal portion 1094 on the lower surface or the side opposite to the visible side of the lower plate glass 1092.

The dye sensitizing solar battery portion 1093 is sealed by a sealing member 1097 between the upper plate glass 1091 and intermediate plate glass 1099. The liquid crystal portion 1094 is sealed by the sealing member 1097 between the intermediate plate glass 1099 and lower plate glass 1092. The sealing member 1097 is preferably made of resin or the like, which is light transmittable. The dye sensitizing solar battery portion 1093 and liquid crystal portion 1094 are placed in being overlapped through the intermediate plate glass 1099.

The dye sensitizing solar battery portion 1093 has a not-shown upper light transmittable electrode provided in the lower surface of the upper plate glass 1091, a not-shown lower light transmittable electrode provided on the upper surface of the intermediate plate glass 1099, a not-shown metal oxide layer absorbing predetermined dyes and a not-shown electric charge transfer layer having a predetermined electrolyte which are sealed between the upper light transmittable electrode and lower light transmittable electrode. The dye sensitizing solar battery portion 1093 is visible through the battery window 1013c formed on the watch-face 1013, and receives external light such as sunlight entered through the battery window 1013c.

The dye sensitizing battery portion 1093 is light transmittable, and can transmit the light emitted by the electroluminescence element 1010 as backlight to the visible side of the wristwatch 1100 through the liquid crystal portion 1094. At that time, the light emitted from the electroluminescence element 1010 is projected to the dye sensitizing solar battery 1093 through the liquid crystal portion 1094.

The liquid crystal portion 1094 has a not-shown upper light transmittable electrode provided on the lower surface of the intermediate plate glass 1099, a not-shown lower light transmittable electrode provided on the upper surface of the lower plate glass 1092, and a not-shown liquid crystal layer sealed between the upper light transmittable electrode and lower light transmittable electrode. The liquid crystal layer (omitted in the drawing) uses a twist mimetic (TN) crystal with a twist angle of 90°, for example.

In the display device 1009, the liquid crystal display consists of a liquid crystal portion 1094 held by the intermediate plate glass 1099 and lower plate glass 1092, a light transmittable polarizing plate 1095 provided corresponding to the liquid crystal portion 1094, and a semi-light transmittable polarizing plate with a reflection plate 1096. Information such as time and date are digitally displayed according to the state of applying a voltage to a pair of not-shown light transmittable electrodes in the liquid crystal portion 1094.

The liquid crystal portion 1094 can be recognized by the dye sensitizing solar battery portion 1093, which is light transmittable, through the window 1013c formed in the watch-face 1013.

The liquid crystal portion 1094 (liquid crystal display) is placed to receive external light such as sunlight entered through a liquid crystal window 1013c formed in the watch-face 1013, and the liquid crystal display (digital display) in the liquid crystal portion 1094 (liquid crystal display) can be recognized through the window 1013c.

By using the light transmittable polarizing plate 1095 as a first polarizing plate and the semi-light transmittable polarizing plate with a reflection plate 1096 as a second polarizing plate, the light emitted from the electroluminescence element 1010 can be transmitted to the visible side through the semi-light transmittable polarizing plate with a reflection plate 1096, and can be projected to the liquid crystal portion 1094 (liquid crystal display). Namely, in a dark place, the liquid crystal portion 1094 (liquid crystal display) can be lit up and recognized by the light emitted from the electroluminescence element 1010 as backlight.

As described above, the display device 1009 is constructed to hold the dye sensitizing solar battery portion 1093 and liquid crystal portion 1094 between the upper plate glass 1091, intermediate plate glass 1099 and lower plate glass 1092, and have the light transmittable polarizing plate 1095 and semi-light transmittable polarizing plate with a reflection plate 1096 at the positions corresponding to the liquid crystal portion 1094, whereby the display device 1009 itself can be light transmittable.

That is, as the light emitted from the electroluminescence element 1010 as backlight reaches the visible side of the wristwatch 1400 passing through the display device 1009 (the dye sensitizing solar battery portion 1093 and liquid crystal portion 1094), the watch-face 1013, hands 1017 on the watch-face 1013 and liquid crystal portion 1094 (liquid crystal display) can be lit up by the light emitted from the electroluminescence element 1010, and the time indicated by the wristwatch 1400 can be recognized in a dark place.

The dye sensitizing solar battery portion 1093 can also generate electric power by the light emitted from the electroluminescence element 1010 from the rear side (lower side) of the dye sensitizing solar battery portion 1093, as well as by sunlight or light from an indoor lamp entered from the visible side. Therefore, the dye sensitizing solar battery portion 1093 of the display device 1009 can efficiently generate electric power.

The generated electric power can be used as a power supply to the wristwatch 1400.

Further, in the display device 1009, as the dye sensitizing solar battery portion 1093 held between the upper plate glass 1091 and intermediate plate glass 1099 is laid on the liquid crystal portion 1094 held between the intermediate plate glass 1099 and lower plate glass 1092 through the intermediate plate glass 1099, the dye sensitizing solar battery portion 1093 and liquid crystal portion 1094 can be placed widely and largely to use effectively the space of the time counting portion 1001 (the upper housing 1011).

As the dye sensitizing solar battery portion 1093 is placed widely and largely, the electric power generated by the dye sensitizing solar battery 1093 can be increased.

As the liquid crystal portion 1094 is placed widely and largely, liquid crystal display (digital display) in the liquid crystal portion 1094 can be enlarged and colorful.

Further, as the dye sensitizing solar battery portion 1093 and liquid crystal portion 1094 are light transmittable, even if the dye sensitizing solar battery portion 1093 is placed just like laid on the front surface of the liquid crystal portion 1094, the liquid crystal display (digital display) in the liquid crystal portion 1094 can be recognized. As the light emitted from the electroluminescence element 1010 as backlight can be projected to the dye sensitizing solar battery 1093 through the liquid crystal portion 1094, the functions of the dye sensitizing solar battery portion 1093 and liquid crystal portion 1094 are not disturbed.

As the wristwatch 1400 has the above display device 1009 in the time counting portion 1001, the liquid crystal portion 1094 of the display device 1009 provides the liquid crystal display function (digital display function), and the dye sensitizing solar battery portion 1093 of the display device 1009 charges the secondary battery 1016.

As the light emitted from the electroluminescence element 1010 passes through the display device 1009 (the dye sensitizing solar battery portion 1093 and liquid crystal portion 1094), and lights up the watch-face 1013, hands 1017 on the watch-face 1013 and liquid crystal portion 1084 (liquid crystal display, the time indicated by the wristwatch 1400 can be recognized even in a dark place.

As the dye sensitizing solar battery portion 1093 of the display device 1009 has the colors based on the dyes contained in a not-shown metal oxide layer, the light emitted from the electroluminescence element 1010 and transmitted through the dye sensitizing solar battery portion 1093 becomes a colored light having the colors corresponding to the various dyes contained in the metal oxide layer. Therefore, the wristwatch 1400 can be a luxurious wristwatch colored by such dyes.

As described above, the fifteenth embodiment can provide the other effects similar to those of the eleventh embodiment.

[Sixteenth Embodiment]

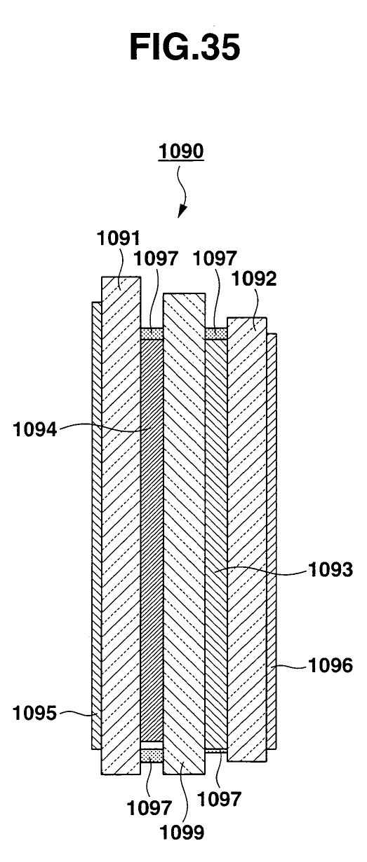

Next, description will be given on a sixteenth embodiment in which the present invention is applied to a wristwatch with reference to FIG. 35. Same reference numerals are given to the same components as those of the eleventh and fifteenth embodiments, and only the different components will be explained.

A display device provided in a time counting portion of a wristwatch according to the present invention can be a display device 1090 having the structure shown in FIG. 35.

The display device 1090 has an upper plate glass 1091 as a first light transmittable plate, a lower plate glass 1092 as a second light transmittable plate placed opposite to the visible side of the upper plate glass 1091, an intermediate plate glass 1099 as an intermediate light transmittable plate placed between the upper plate glass 1091 and lower plate glass 1092, a liquid crystal portion 109 placed between the upper plate glass 1091 and intermediate plate glass 1099, a dye sensitizing solar battery portion 1093 as a solar battery portion placed between the intermediate plate glass 1099 and lower plate glass 1092, a light transmittable polarizing plate 1095 as a first polarizing plate placed corresponding to the liquid crystal portion 1094 on the upper surface or the visible side of the upper plate glass 1091, and a semi-light transmittable polarizing plate with a reflection plate 1096 as a second polarizing plate placed corresponding to the liquid crystal portion 1094 on the lower surface or the side opposite to the visible side of the lower plate glass 1092.

The liquid crystal portion 1094 is sealed by a sealing member 1097 between the upper plate glass 1091 and intermediate plate glass 1099. The dye sensitizing solar battery portion 1093 is sealed by the sealing member 1097 between the intermediate plate glass 1099 and lower plate glass 1092. The sealing member 1097 is preferably made of resin or the like, which is light transmittable. The dye sensitizing solar battery portion 1093 and liquid crystal portion 1094 are placed in being overlapped through the intermediate plate glass 1099.

The display device 1090 configured as described above is constructed to be light transmittable in the display device 1090 itself.

Namely, the dye sensitizing solar battery portion 1093 is placed to receive external light such as sunlight entered from the window 1013c formed in the watch-face 1013 through the liquid crystal portion 1094. The dye sensitizing solar battery portion 1093 is placed also to receive the light emitted from the electroluminescence element 1010 as backlight through the semi-light transmittable polarizing plate with a reflection plate 1096.

The liquid crystal portion 1094 is placed to receive external light such as sunlight entered through the window 1013c formed in the watch-face 1013, and to receive the light emitted from the electroluminescence element 1010 as backlight through the semi-light transmittable polarizing plate with a reflection plate 1096 and dye sensitizing solar battery portion 1093. Thus, the liquid crystal display (digital display) in the liquid crystal portion 1094 (liquid crystal display) can be recognized through the window 1013c.

The display device 1090 can be lit up of course by the backlight (electroluminescence element 1010) provided opposite to the visible side of the display device 1090, and also by the light from the front light provided on the visible side of the display device 1090, and the sidelight provided at the periphery side portion of the display device 1090, that is, by the light outputted from these lights (light-emitting element and light-projecting portion). Both of the dye sensitizing solar battery portion 1093 and liquid crystal portion 1094 of the display device 1090 can be lit up by these lights.

By providing such a display device 1090 in a wristwatch, the wristwatch is given a liquid crystal display function (digital display function) by the liquid crystal portion 1094 of the display device 1090. The secondary battery 1016 is charged by the dye sensitizing solar battery portion 1093 of the display device 1090.

Of course, the sixteenth embodiment can provide the other effects similar to those of the eleventh and fifteenth embodiments.

[Seventeenth Embodiment]

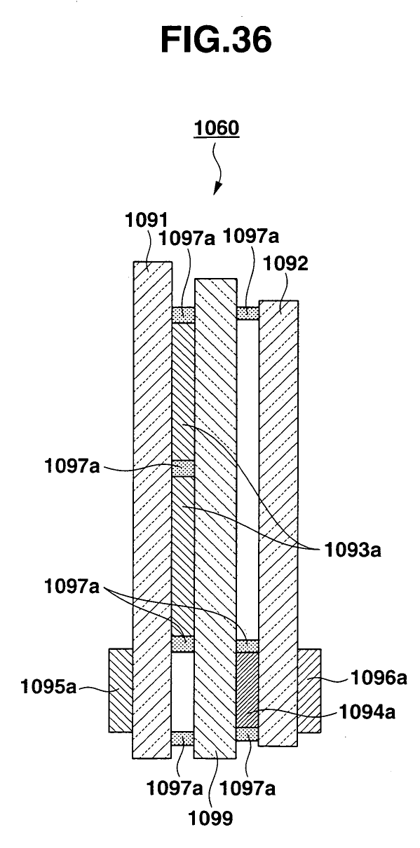

Next, description will be given on a seventeenth embodiment in which the present invention is applied to a wristwatch with reference to FIG. 36. Same reference numerals are given to the same components as those of the eleventh and fifteenth embodiments, and only the different components will be explained.

A display device provided in a time counting portion of a wristwatch according to the present invention can be a display device 1060 having the structure shown in FIG. 36.

The display device 1060 has an upper plate glass 1091 as a first light transmittable plate, a lower plate glass 1092 as a second light transmittable plate placed opposite to the visible side of the upper plate glass 1091, an intermediate plate glass 1099 as an intermediate light transmittable plate placed between the upper plate glass 1091 and lower plate glass 1092, a dye sensitizing solar battery portion 1093a as a solar battery portion placed in a first area between the upper plate glass 1091 and intermediate plate glass 1099, a liquid crystal portion 1094a placed in a second area between the intermediate plate glass 1099 and lower plate glass 1092, a light transmittable polarizing plate 1095a as a first polarizing plate placed corresponding to the liquid crystal portion 1094a on the upper surface or the visible side of the upper plate glass 1091, and a semi-light transmittable polarizing plate with a reflection plate 1096a as a second polarizing plate placed corresponding to the liquid crystal portion 1094a on the lower surface or the side opposite to the visible side of the lower plate glass 1092.

The dye sensitizing solar battery portion 1093a is sealed by a sealing member 1097a between the upper plate glass 1091 and intermediate plate glass 1099. The liquid crystal portion 1094a is sealed by the sealing member 1097a between the intermediate plate glass 1099 and lower plate glass 1092. The sealing member 1097a is preferably made of resin or the like, which is light transmittable.

The display device 1060 is constructed by providing an intermediate plate glass 1096 in the display device 1008 of the eleventh embodiment, and placing the dye sensitizing solar battery portion 1093a and liquid crystal portion 1094a in the respective areas through the intermediate plate glass 1099.

In the display device 1060, by placing the dye sensitizing solar battery portion 1093a and liquid crystal portion 1094a between the different glass plates, it is easy to form the wiring (omitted in the drawing) extending from the not-shown light transmittable electrodes (the upper light transmittable electrode and lower light transmittable electrode) in the liquid crystal portion 1094a.

Namely, in the display device 1060, the dye sensitizing solar battery 1093a and liquid crystal portion 1094a are not placed between the same glass plates as in the display device 1008 of the eleventh embodiment. Only the liquid crystal portion 1094a is placed between the intermediate plate glass 1099 and lower plate glass 1092 in the display device 1060, and the configuration concerning only the liquid crystal portion 1094a can be made. Thus, the degree of flexibility in forming the wiring (omitted in the drawing) extending from the not-shown light transmittable electrodes of the liquid crystal portion 1094a can be increased between the intermediate plate glass 1099 and lower plate glass 1092, and the wiring (omitted in the drawing) can be easily formed. The wiring (omitted in the drawing) is connected to the connector 1018.

The display device 1060 configured as described above is constructed to be light transmittable in the display device 1060 itself.

Therefore, the display device 1060 can be lit up of course by the front light provided in the visible side of the display device 1060, and also by the light from the backlight provided opposite to the visible side of the display device 1060, and the sidelight provided at the periphery side portion of the display device 1060, that is, by the light outputted from these lights (light-emitting element and light-projecting portion). Both of the dye sensitizing solar battery portion 1093a and liquid crystal portion 1094a of the display device 1060 can be lit up by these lights.

It is permitted to place the dye sensitizing solar battery portion 1093a between the intermediate plate glass 1099 and lower plate glass 1092, and the liquid crystal portion 1094a between the upper plate glass 1091 and intermediate plate glass 1099.

By providing such a display device 1060 in a wristwatch, the wristwatch is given a liquid crystal display function (digital display function) by the liquid crystal portion 1094a of the display device 1060. The secondary battery 1016 is charged by the dye sensitizing solar battery portion 1093a of the display device 1060.

Of course, the seventeenth embodiment can provide the other effects similar to those of the eleventh and fifteenth embodiments.

[Eighteenth Embodiment]

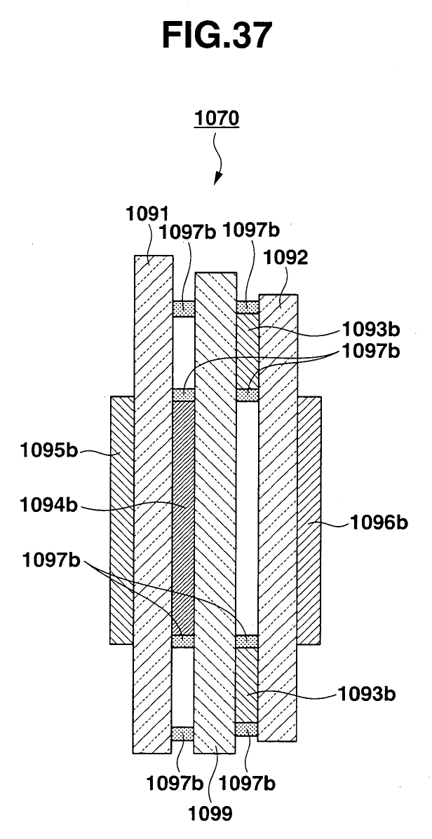

Next, description will be given on an eighteenth embodiment in which the present invention is applied to a wristwatch with reference to FIG. 37. Same reference numerals are given to the same components as those of the eleventh and fifteenth embodiments, and only the different components will be explained.

A display device provided in a time counting portion of a wristwatch according to the present invention can be a display device 1070 having the structure shown in FIG. 37.

The display device 1070 has an upper plate glass 1091 as a first light transmittable plate, a lower plate glass 1092 as a second light transmittable plate placed opposite to the visible side of the upper plate glass 1091, an intermediate plate glass 1099 as an intermediate light transmittable plate placed between the upper plate glass 1091 and lower plate glass 1092, a dye sensitizing solar battery portion 1093b as a solar battery portion placed in a first area between the intermediate plate glass 1099 and lower plate glass 1092, a liquid crystal portion 1094b placed in a second area between the upper plate glass 1091 and intermediate plate glass 1099, a light transmittable polarizing plate 1095b as a first polarizing plate placed corresponding to the liquid crystal portion 1094b on the upper surface or the visible side of the upper plate glass 1091, and a semi-light transmittable polarizing plate with a reflection plate 1096b as a second polarizing plate placed corresponding to the liquid crystal portion 1094b on the lower surface or the side opposite to the visible side of the lower plate glass 1092.

The dye sensitizing solar battery portion 1093b is sealed by a sealing member 1097b between the intermediate plate glass 1099 and lower plate glass 1092. The liquid crystal portion 1094b is sealed by the sealing member 1097b between the upper plate glass 1091 and intermediate plate glass 1099. The sealing member 1097b is preferably made of resin or the like, which is light transmittable.

The display device 1070 is constructed by providing an intermediate plate glass 1096 in the display device 1080 of the fourteenth embodiment, and placing the dye sensitizing solar battery portion and liquid crystal portion in the respective areas through the intermediate plate glass 1099.

In the display device 1070, by placing the dye sensitizing solar battery portion 1093b and liquid crystal portion 1094b between the different glass plates, it is easy to form the wiring (omitted in the drawing) extending from the not-shown light transmittable electrodes (the upper light transmittable electrode and lower light transmittable electrode) in the liquid crystal portion 1094b.

Namely, in the display device 1070, the dye sensitizing solar battery 1093b and liquid crystal portion 1094b are not placed between the same glass plates as in the display device 1080 of the fourteenth embodiment. Only the liquid crystal portion 1094b is placed between the upper plate glass 1091 and intermediate plate glass 1099 in the display device 1070, and the configuration concerning only the liquid crystal portion 1094b can be made. Thus, the degree of flexibility in forming the wiring (omitted in the drawing) extending from the not-shown light transmittable electrodes of the liquid crystal portion 1094b can be increased between the upper plate glass 1091 and intermediate plate glass 1099, and the wiring (omitted in the drawing) can be easily formed. The wiring (omitted in the drawing) is connected to the connector 1018.

The display device 1070 configured as described above is constructed to be light transmittable in the display device 1070 itself.

Therefore, the display device 1070 can be lit up of course by the front light provided in the visible side of the display device 1070, and also by the light from the backlight provided opposite to the visible side of the display device 1070, and the sidelight provided at the periphery side portion of the display device 1070, that is, by the light outputted from these lights (light-emitting element and light-projecting portion). Both of the dye sensitizing solar battery portion 1093b and liquid crystal portion 1094b of the display device 1070 can be lit up by these lights.

It is permitted to place the liquid crystal portion 1094b between the intermediate plate glass 1099 and lower plate glass 1092, and the dye sensitizing solar battery portion 1093b between the upper plate glass 1091 and intermediate plate glass 1099.

By providing such a display device 1070 in a wristwatch, the wristwatch is given a liquid crystal display function (digital display function) by the liquid crystal portion 1094b of the display device 1070. The secondary battery 1016 is charged by the dye sensitizing solar battery portion 1093b of the display device 1070.

Of course, the eighteenth embodiment can provide the other effects similar to those of the eleventh and fifteenth embodiments.

According to the first to eighteenth embodiments, it is possible to project light to both of a dye sensitizing solar battery area and liquid crystal portion area in a display device by one light-emitting element by providing a dye sensitizing solar battery portion and liquid crystal portion in different areas between a first light transmittable plate and second light transmittable plate.

With the above configuration, the dye sensitizing solar battery portion can generate electric power when receiving light, and liquid crystal display in the liquid crystal portion can be recognized in a dark place. Further, as the light-projecting portion projects light to both of the dye sensitizing solar battery portion and the liquid crystal portion, the cost can be decreased, compared with the case that two light-projecting portions for both of them are separately provided.

It is also possible to place a dye sensitizing solar battery portion and liquid crystal portion in being overlapped in a display device by providing a dye sensitizing solar battery portion being light transmittable between a first light transmittable plate and intermediate light transmittable plate, and by providing a liquid crystal portion between an intermediate light transmittable plate and second light transmittable plate, or by providing a liquid crystal portion between a first light transmittable plate and intermediate light transmittable plate, and providing a dye sensitizing solar battery portion being light transmittable between an intermediate light transmit-table plate and second light transmittable plate.

With the above configuration, the light-receiving area of a solar battery can be enlarged as compared with the unit using a conventional solar battery, and the volume of generated electric power can be increased. This makes the display device compact.

Further, as the display device itself is light transmittable, even if the dye sensitizing solar battery portion and liquid crystal portion are overlapped, the liquid crystal portion can be visually recognized through the dye sensitizing solar battery portion, and light can be projected to the solar battery portion through the liquid crystal portion. Thus, the functions of the solar battery portion and liquid crystal portion don't disturb each other.

Therefore, the efficiency of electric power generation can be increased by making the solar battery portion large and placing widely. The variations of liquid crystal display can be increased by making the liquid crystal large and placing widely. Further, the sizes of the liquid crystal portion and solar battery portion are unchanged, the display device itself can be made compact by overlapping the solar battery portion and liquid crystal portion.

In the above eleventh to eighteenth embodiments, a wristwatch is taken as an example of electronic apparatus. But, the present invention is not limited to a wristwatch. Electronic apparatus may be a cellular phone, PDA, personal computer, automobile instruments and other various apparatus.

As a dye in the dye sensitizing solar battery portion, ruthenium is taken as an example, but other dyes such as merocyanin coumarin and phenanthroline groups can be used.

A dye sensitizing solar battery portion is taken as an example as a solar battery portion. The present invention is not limited to this. Any solar battery can be used as long as it is light transmittable.

Of course, the other concrete detail structures can also be modified appropriately.

[Nineteenth Embodiment]

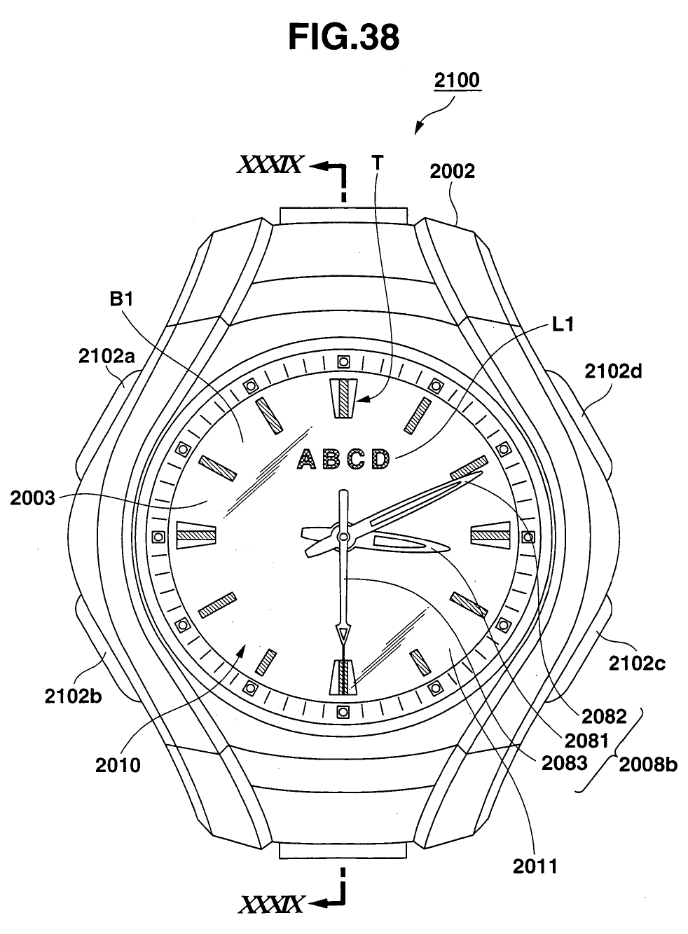

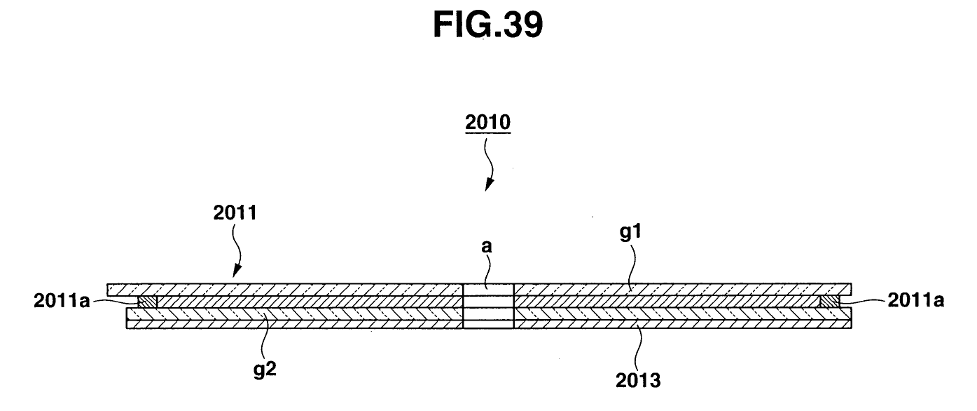

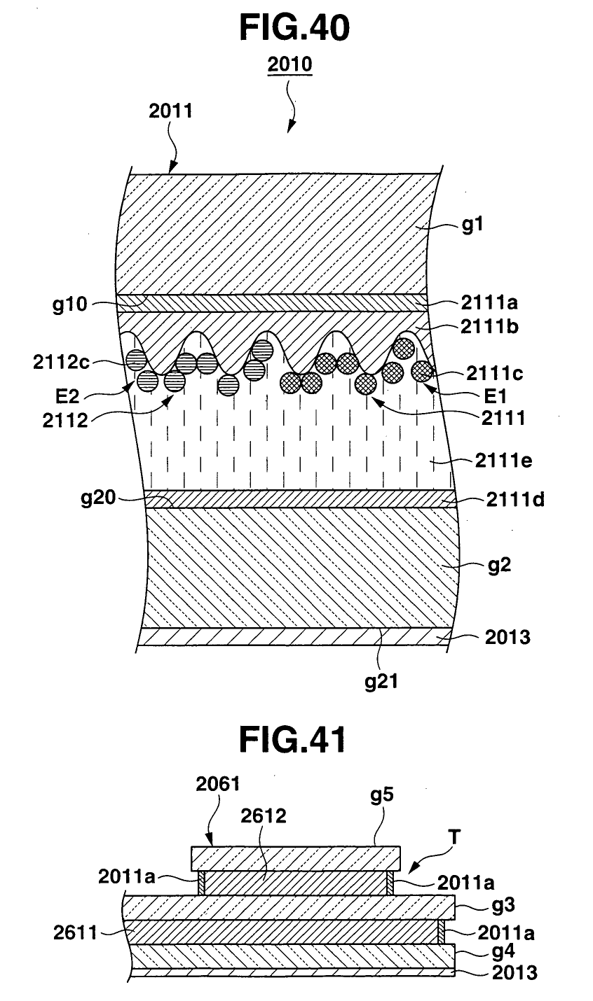

Next, description will be given on a nineteenth embodiment in which the present invention is applied to a wristwatch with reference to FIG. 38, FIG. 39 and FIG. 40. FIG. 38 is a plane view showing a wristwatch according to a nineteenth embodiment of the present invention. FIG. 39 is a sectional view of the ornament device of the wristwatch. FIG. 40 is an enlarged view of the main portion of the ornament device of the wristwatch.

In the nineteenth embodiment, a dye sensitizing solar battery 2011 having several dyes is used for the dye sensitizing solar battery 11, 91 and 111 in the first to tenth embodiments, and the dye sensitizing solar battery portion 1083, 1083a, 1093, 1093aand 1093b in the eleventh to eighteenth embodiments. The dye sensitizing solar battery 2011 having several dyes will be mainly explained hereinafter.

Description will be given on the above dye sensitizing solar battery according to the present invention applied to a wristwatch as an electronic apparatus hereinafter with reference to FIG. 38, FIG. 39 and FIG. 40.

First, the whole configuration of a wristwatch 2100 will be explained.

As shown in FIG. 38, the wristwatch 2100 has a watch case 2002 as a cylindrical apparatus case to house a time counting portion (omitted in the drawing). In the upper portion of the watch case 2002, a watch glass 2003 to cover the opening on the sunlight incident side is fit.

At the periphery of the watch case 2002, switches 2102a, 2102b, 2102c and 2102d to execute various functions of the wristwatch 2100 are provided.

In the lower portion of the clock glass 2003, an ornament device 2010 is provided. The ornament device includes a dye sensitizing solar battery 2011 consisting of several dyes different from time mark T, letters L1 and background area B1, for example.

The dye sensitizing solar battery 11 has a shaft hole SH. A hand shaft (omitted in the drawing) is extended upward from the shaft hole SH. A hand group 2008b consisting of an hour hand 2081, minute hand 2082 and second hand 2083 are fixed to the hand shafts. The hand group 2008b are arranged to move on the dye sensitizing solar battery 2011.

Next, the ornament device 2010 will be explained.

As shown in FIG. 39, the ornament device 2010 has a dye sensitizing solar battery 2011, and a luminous member 2013 provided opposite to the sunlight incident side of the dye sensitizing solar battery 2011.

First, the dye sensitizing solar battery 2011 will be explained.

As shown in FIG. 39 and FIG. 40, the dye sensitizing solar battery 2011 has an upper plate glass g1 as a first light transmittable plate, a lower plate glass g2 as a second light transmittable plate placed opposite to the upper plate glass g1, a first dye sensitizing solar battery layer 2111 provided in a first area E1 between the upper plate glass g1 and lower plate glass g2, and a second dye sensitizing solar battery layer 2112 provided in a second area E2 between the upper plate glass g1 and lower plate glass g2.

The first dye sensitizing solar battery layer 2111 has a first light transmittable electrode 2111a stacked on the inner surface g10 (lower surface) of the upper plate glass g1, titanium oxide layer 2111b (hereinafter, called a TiO₂ layer) as a metal oxide layer stacked on the first light transmittable electrode 2111a, a first light sensitizing dye 2111c (e.g., orange light sensitizing dye) absorbed in the TiO₂ layer 2111b, and a second light transmittable electrode 2111d stacked on the inner surface g20 (upper surface) of the lower plate glass g2 and placed opposite to the first light transmittable electrode 2111a.

As the first light sensitizing dye 2111c, any dye which can absorb the light capable of generating electromotive force can be used. As such a dye, transition metal complex, such as a ruthenium complex, osmium complex, rhodium complex and palladium complex, or ruthenium-cis-diaqua-bipylsil complex, or a so-called metal chelate complex, such as phthalocyanine, porphyrin, dithiolate complex, acetylacetonate cpmplex, organic dyes, such as cyanidine dye, meocyanine dye, rhodamine dye, and an oxadiazole derivative, benzothiazole derivative, coumarin derivative, stilbenederivative, and organic chemicals having aromatic are preferable. These dyes are preferably large in the extinction coefficient and stable against the repetitive oxidation-reduction. The dye molecule may be a low molecule compound, or a polymer having a repeating unit.

The first light sensitizing dye 2111c is preferably chemically absorbed on the TiO₂ layer 2111b, and has a functional groups, such as, carboxyl group, sulfone group, phosporic acid group, amide group, amino group, carbonyl group, phosphine group. These functional groups preferably exist in several number in a dye molecule.

As shown in FIG. 40, the TiO₂ layer 2111b is preferably porous to absorb much first light sensitizing dye 2111c.

Electrolytic solution 2111e to transfer the electron emitted from the first light sensitizing dye 2111c is sealed by a sealing member 2011a between the upper plate glass g1 and lower plate glass g2. As the electrolytic solution 2111e, add lithium iodide to polyethylene glycol, for example, or use a solution including lithium iodide or cerium (III) sulfate.

When external light is projected to the first dye sensitizing solar battery layer 2111, the first light sensitizing dye 2111c absorbs the light energy and emits an electron. The emitted electron is transferred to the first light transmittable electrode 2111a through the TiO₂ layer 2111b, and sent from the first light transmittable electrode 2111a to a given external load resistor (e.g., a not-shown electronic circuit). The electron transferred through the load resistor is sent to the second light transmittable electrode 2111d, and then returned to the first light sensitizing dye 2111c through the electrolytic layer 2111e.

As described above, a current is generated by this circulation of electron, and electric energy can be generated and supplied to the load resistor.

The second dye sensitizing solar battery layer 2112 has the same configuration as the first dye sensitizing solar battery layer 2111, except that the color (e.g., blue) of the second light sensitizing dye 2112c is different from the first light sensitizing dye 2111c. Thus, a detailed explanation will be omitted.

The color of the second light sensitizing dye 2112c becomes the color of the second dye sensitizing solar battery layer 2112.

As shown in FIG. 38, the dye sensitizing solar battery 2011 has a background area B1, time marks T and letters L1 which are discriminated by the colors of the first dye sensitizing solar battery layer 2111 and second dye sensitizing solar battery layer 2112.

The background area B1 includes all areas of the dye sensitizing solar battery 2011 except for the time marks T and letters L1, for example, as shown in FIG. 38.

More concretely, the background area B1 is orange, for example. That is, as shown in FIG. 40, the portion of the background area B1 is the portion corresponding to the first dye sensitizing solar battery layer 2111.

Therefore, the first area E1 itself in which the first dye sensitizing solar battery layer 2111 is provided is the portion of the background area B1.

The time marks T are substantially rectangular plane patterns and provided at 12 locations with equal intervals in the circumference, for example, as shown in FIG. 38. When the time marks T are indicated by the hand group 2008b, the current time can be known.

More concretely, the time marks T are blue, for example. Namely, as shown in FIG. 40, the portion of the time marks T is the portion corresponding to the second dye sensitizing solar battery layer 2112. The time marks T are discriminated by the color of the second dye sensitizing solar battery layer 2112 and the color of the first sensitizing solar battery layer 2111, that is, the color of the background area B1.

Therefore, the second area E2 itself in which the second dye sensitizing solar battery layer 2112 is provided is the portion of the time marks T.

The letters L1 are character information indicating a company name or a product name, for example. Concretely, four alphabets A, B, C and D close to the portion corresponding to 12 o'clock of the time marks T form “ABCD” of the letters L1, for example, as shown in FIG. 38.

More concretely, the letters L1 are green, for example. Namely, the letters L1 are the portion corresponding to the third color sensitizing solar battery layer (omitted in the drawing) having a green third light sensitizing dye (omitted in the drawing). Namely, the letters L1 are discriminated by the color of the third dye sensitizing solar battery layer and the color of the first dye sensitizing solar battery layer 2111, that is, the color of the background area B1.

The wristwatch 2100 described above has time marks T which are discriminated by the colors of the first dye sensitizing solar battery layer 2111 and second dye sensitizing solar battery layer 2112. Therefore, as these dye sensitizing solar battery layers have both functions of photoelectric conversion and ornament portion (time marks), the ornament area can be increased without decreasing the volume of electric power generated by the dye sensitizing solar battery 2011, and the flexibility of ornament portion can be increased. This satisfies the user's needs.

Further, as the luminous member 2013 is provided in the lower plate glass g2 of the dye sensitizing solar battery 2011 and the luminous member 2013 charged with external light emits light at night, the colors of the time marks T and letters L1 can be recognized at night. Besides, as the luminous member 2013 can generate electric power by emitting light, the efficiency of generating electric power can be increased.

In the above embodiment, the lower plate glass g2 is light transmittable. But, it is permitted to use a non-light transmittable plate instead of the lower plate glass g2.

The number of dye sensitizing solar battery layers is not limited to three. The number may be set appropriately according to the design.

The metal oxide layer is not limited to the TiO₂ layer 111b. For example, a zinc oxide (ZnO) layer may be used.

[First Modification]

A first modification of the nineteenth embodiment will be explained.

In the nineteenth embodiment, the luminous member 201 is provided in all areas of the outer surface g21 of the lower plate glass. But, it is possible to provide the luminous member 2013 only in the portion corresponding to right under the time marks T. It is also permitted to apply a luminous member 2013 such as light storing paint to the sunlight incident surface of hour hand 2081, minute hand 2082 and second hand 2083 of the hand group 2008b.

Namely, in the nineteenth embodiment, all of the background area B1, time marks T and letters L1 (refer to FIG. 38) are visually recognized at night by the light emitted from the luminous member 2013. However, in the above modification, the time marks T and hand group 2008b are recognized by the light emitted from the luminous member 2013. This permits recognition of time at night, and decreases the power consumption of the luminous member 2013.

[Second Modification]

Next, a second modification of the nineteenth embodiment will be explained with reference to FIG. 41.

FIG. 41 is an enlarged view of the main portion of an ornament device as a second modification. The second modification is different from the nineteenth embodiment in the point that the time marks T have a dye sensitizing solar battery. The others are the same as the nineteenth embodiment. Only the different point will be explained hereinafter.

A dye sensitizing solar battery 2061 has an intermediate plate glass g3 as a first light transmittable plate, a lower plate glass g4 as a second light transmittable plate provided opposite to the sunlight incident side of the intermediate glass g3, an upper plate glass g5 as a third light transmittable plate provided on the sunlight incident side of the intermediate glass g3, a first dye sensitizing solar battery layer 2611 provided between the intermediate glass g3 and lower plate glass g4, and a second dye sensitizing solar battery layer 2612 provided between the intermediate glass g3 and upper plate glass g5.

According to the second modification of the nineteenth embodiment, the time marks T are discriminated by the composite color made by the colors of the first dye sensitizing solar battery layer 2611 and second dye sensitizing solar battery layer 2612. As each dye sensitizing solar battery layer has both functions of photoelectric conversion and an ornament portion, the ornament area can be increased without decreasing the volume of electric power generated by the dye sensitizing solar battery 2061, and the flexibility of ornament portion can be increased. This satisfies the user's needs.

The number of dye sensitizing solar battery layers is not limited to two, and may be set appropriately according to the design.

In the above nineteenth embodiment and first and second modifications, a wristwatch and cellular phone are taken as examples of electronic apparatus. But, the present invention is not limited to them. Electronic apparatus may be a PDA, personal computer, automobile instruments and other various apparatus.

The time marks may be numerals, such as Arabic numerals, Roman numerals, or figures, such as circle and ellipse.

The number and location of the time marks and letters are also not limited.

1. An ornament device comprising:
a light transmittable dye sensitizing solar battery, which has a pair of light transmittable plates and a dye sensitizing solar battery element provided between the pair of light transmittable plates; and
a light-projecting member, which is provided in the side of the dye sensitizing solar battery opposite to the sunlight incident side thereof and projects light to the solar battery.

2. The ornament device according to claim 1, further comprising an ornament portion, which is provided at least one of the pair of light transmittable plates.

3. The ornament device according to claim 2, wherein the ornament portion is formed on the outer surface of the at least one of the pair of light transmittable plates by one of printing, planting, sticking and etching.

4. The ornament device according to claim 1, wherein the light-projecting member has a light-emitting element, which emits light, and a light guide plate, in which the light emitted from the light-emitting element is introduced and which projects the introduced light to the dye sensitizing solar battery.

5. The ornament device according to claim 1, wherein an ornament portion is provided on the outer surface of the light-projecting member is provided with on.

6. The ornament device according to claim 5, wherein the ornament portion is formed on the outer surface of the light-projecting member by one of printing planting, and sticking.

7. The ornament device according to claim 1, wherein the light-projecting member has a light-emitting element, which emits light, and a light guide plate, into which the light emitted from the light-emitting element is introduced, which projects the introduced light to the dye sensitizing solar battery, and on the outer surface of which an ornament portion is provided.

8. The ornament device according to claim 1, further comprising an ornament plate, which is light transmittable and which is arranged in the sunlight incident side of the dye sensitizing solar battery, and an ornament portion, which is formed on the ornament plate and which includes one of a figure, a pattern and a letter.

9. The ornament device according to claim 8, wherein the ornament portion is formed on the sunlight incident surface of the ornament plate by one of printing, planting, sticking and etching.

10. The ornament device according to claim 1, further comprising:
an ornament plate, which is light transmittable and which is provided in the side of the dye sensitizing solar battery opposite to the sunlight incident side thereof;
a light-projecting member, which is provided in the side of the dye sensitizing solar battery opposite to the sunlight incident surface of the ornament plate and which projects light to the dye sensitizing solar battery; and
an ornament portion, which is formed on the ornament plate and which includes at least one of a figure, a pattern and a letter.

11. The ornament device according to claim 10, wherein the ornament portion is formed on the sunlight incident surface of the ornament plate by one of printing, planting, sticking and etching.

12. The ornament device according to claim 1, further comprising a liquid crystal display, which has a pair of light transmittable plates and a liquid crystal portion provided in an area between the pair of light transmittable plates, the area being different from the area provided with the dye sensitizing solar battery element between the pair of light transmittable plates; and
wherein the light-projecting member projects light to both of the area provided with the dye sensitizing solar battery element and the area provided with the liquid crystal portion.

13. An electronic apparatus comprising:
a light transmittable dye sensitizing solar battery, which has a pair of light transmittable plates and a dye sensitizing solar battery element provided between the pair of light transmittable plates;
a light-projecting member, which is provided in the side of the dye sensitizing solar battery opposite to the sunlight incident side thereof and projects light to the dye sensitizing solar battery;
an ornament portion, which is provided on at least one of the pair of light transmittable plates; and
an apparatus case, which houses the light transmittable dye sensitizing solar battery, light-projecting member and ornament portion.

14. The electronic apparatus according to claim 13, further comprising a hand group, which is provided in the sunlight incident side of the dye sensitizing solar battery and ornament portion and which indicates time, and a driving portion, which drives the hand group, and
Wherein the ornament portion includes a time mark indicated by the hand group.

15. The ornament device according to claim 1, further comprising a plurality of dye sensitizing solar battery layers with different dyes provided between the pair of light transmittable plates.

16. The ornament device according to claim 1, further comprising another light transmittable plate, which is provided in the sunlight incident side of the pairs of light transmittable plates; and
another dye sensitizing solar battery layer, which has a dye different from the dye of the dye sensitizing solar battery layer provided between the pair of light transmittable plates and which is placed between another light transmittable plate and the pair of light transmittable plates.

17. A display device comprising:
a dye sensitizing solar battery portion, which is a light transmittable and which is provided in a first area between a first light transmittable plate and a second light transmittable plate; and
a liquid crystal portion, which is provided in a second area between the first light transmittable plate and the second light transmittable plate.

18. The display device according to claim 17, further comprising a light-projecting portion, which projects light to both of the dye sensitizing solar battery portion and the liquid crystal portion, and the light-projecting portion being provided at least one of a position in the visible side of both of the dye sensitizing solar battery portion and the liquid crystal portion, a position in the side of both of the dye sensitizing solar battery portion and the liquid crystal portion opposite to the visible side thereof, and a position in a lateral side of both of the dye sensitizing solar battery portion and the liquid crystal portion.

19. A display device comprising:
first and second light transmittable plates;
an intermediate light transmittable plate, which is provided between the first and second light transmittable plates such that the first, intermediate and second light transmittable plates are arranged with predetermined intervals;
a dye sensitizing solar battery portion, which is light transmittable and which is provided in one of the space between the first light transmittable plate and the intermediate light transmittable plate and the space between the intermediate light transmittable plate and the second light transmittable plate; and
a liquid crystal portion, which is provided in the other of the space between the first light transmittable plate and the intermediate light transmittable plate and the space between the intermediate light transmittable plate and the second light transmittable plate.

20. The display device according to claim 19, wherein the dye sensitizing solar battery portion and the liquid crystal portion are overlapped each other at least portions thereof with the intermediate light transmittable plate being interposed therebetween.

21. The display device according to claim 19, further comprising a light-projecting portion, which projects light to both of the dye sensitizing solar battery portion and the liquid crystal portion, and the light-projecting portion being provided at least one of a position in the visible side of both of the dye sensitizing solar battery portion and the liquid crystal portion, a position in the side of both of the dye sensitizing solar battery portion and the liquid crystal portion opposite to the visible side thereof, and a position in the lateral side of both of the dye sensitizing solar battery portion and the liquid crystal portion.

22. An electronic apparatus comprising:
a dye sensitizing solar battery portion, which is light transmittable and which is provided in a first area between a first light transmittable plate and a second light transmittable pate; and
a liquid crystal portion, which is provided in a second area between the first light transmittable plate and the second light transmittable pate; and
an apparatus case, which houses the solar battery portion and the liquid crystal portion.
